(19) United States
(12) Patent Application Publication
(10) Pub. No.: US 2015/0151863 A1
(43) Pub. Date: Jun. 4, 2015

(54) MATERIAL HANDLING MACHINE

(71) Applicant: Sandbags, LLC, Las Vegas, NV (US)

(72) Inventors: Michael D. BORDEN, Las Vegas, NV (US); Angus Robert COLSON, Jamul, CA (US); Dale W. DOWERS, Las Vegas, NV (US); Regina Whitney ROBERTS, Valley Center, CA (US); Hugh Owen WILLIAMS, Oceanside, CA (US); Brian P. GALLOGLY, Yorba Linda, CA (US)

(21) Appl. No.: 14/480,545

(22) Filed: Sep. 8, 2014

Related U.S. Application Data
(60) Provisional application No. 61/875,496, filed on Sep. 9, 2013.

(51) Int. Cl. B65B 37/14; B65G 65/42; B65B 57/00; B65B 25/02; B65B 37/02; B65G 37/00; B65B 51/07

(52) U.S. Cl. CPC B65B 37/14; B65G 37/00; B65G 65/42; B65B 51/07; B65B 25/02; B65B 37/02; B65B 57/005

(57) ABSTRACT

Material handling machines of the present technology can be used to bag material, such as sand. The material handling machines can include a hopper and material conveyor assembly, which can automatically fill bags with a predetermined volume of material. The material handling machines can also include production lines that receives filled bags and conveys them to storage sacks for transportation to or use at a desired location.

### CROSS REFERENCE TO RELATED APPLICATION

This application is based on and derives the benefit of the filing date of U.S. Provisional Patent Application No. 61/875,496, filed Sep. 9, 2013, the contents of which are incorporated herein by reference in their entirety.

### BRIEF DESCRIPTION OF THE DRAWINGS

Specific examples have been chosen for purposes of illustration and description, and are shown in the accompanying drawings, forming a part of the specification.

FIG. 1 illustrates one example of a material handling machine of the present technology, with the covers on and doors closed.

FIG. 2 illustrates the material handling machine of FIG. 1, with the covers off and the doors open.

FIG. 3 illustrates the hopper and conveyor assembly of FIG. 1, with the conveyor belt and head removed on the left side.

FIG. 4 illustrates an isolated material conveyor of the hopper and conveyor assembly of FIG. 3, with the conveyor belt removed.

FIG. 5 illustrates a conveyor head and chute of the hopper and conveyor assembly of FIG. 3.

FIG. 6 illustrates a hopper of the hopper and conveyor assembly of FIG. 3, with the conveyor belts removed.

FIG. 7 illustrates a portion of the hopper and conveyor assembly of FIG. 3, with the hopper gate closed.

FIG. 8 illustrates the portion of the hopper and conveyor assembly of FIG. 7, with the hopper gate open.

FIG. 9 illustrates an isolated chute of the of the hopper and conveyor assembly of FIG. 3.

FIG. 10 illustrates the chute of FIG. 9.

FIG. 11 illustrates the conveyor head of FIG. 5, with the cover removed.

FIG. 12 illustrates a cover grate of the material handling machine of FIG. 1, with the cover grate in a lowered position.

FIG. 13 illustrates the cover grate of FIG. 12, with the cover grate in a raised position.

FIG. 14 illustrates a portion of an underside of hopper and conveyor assembly of FIG. 3.

FIG. 15 illustrates a portion of the underside of hopper and conveyor assembly of FIG. 14, with cutaways to show internal features.

FIG. 16 illustrates a portion of the material handling machine of FIG. 1, underneath the hopper, with a vent door and fans.

FIG. 17 illustrates the fans of FIG. 16.

FIG. 18 illustrates the back end of a material handling machine of FIG. 1, with the production line in an operation position.

FIG. 19 illustrates the back end of a material handling machine of FIG. 1, with conveyors of the production line in a partially stowed position.

FIG. 20 illustrates a tower of the material handling machine of FIG. 1.

FIG. 21 illustrates a head of the tower of FIG. 20.

FIG. 22 illustrates an exploded view of a shuttle conveyor and shuttle conveyor stand of the production line of FIG. 18.

FIG. 23 illustrates an exploded view of a storage sack stand of the production line of FIG. 18.

FIG. 24 illustrates a shuttle conveyor and storage sack assembly of the production line of FIG. 18 in operation, filling a first storage sack.

FIG. 25 illustrates the shuttle conveyor and storage sack assembly of FIG. 24, in operation, filling a second storage sack.

FIG. 26 is a block diagram of the overall operating process for the material handling machine of FIG. 1.

FIG. 27 is a block diagram of the start-up process for the generator that can be performed at step 1 of the process of FIG. 29.

FIG. 28 is a block diagram of the start-up process for the air compressor that can be performed at step 2 of the process of FIG. 29.

FIG. 29 is a block diagram of the start-up process for the hydraulic system that can be performed at step 3 of the process of FIG. 29.

FIG. 30 is a block diagram of the initialization process for start-up of the conveyor system that can be performed at step 4 of the process of FIG. 29.

FIG. 31 is a block diagram of the tower logic start-up process that can be performed at step 5 of the process of FIG. 29.

FIG. 32 is a block diagram of the operation process that can be performed at step 6 of the process of FIG. 29.

FIG. 33 is a block diagram of the operation process of the production line of the material handling machine that can be performed at step 7 of the process of FIG. 29.

FIG. 34 is a block diagram of the operation of the conveyor belt speed adjustment and speed control that can be performed at step 8 of the process of FIG. 29.

FIG. 35 is a block diagram of the operation process of the hydraulic cooling fans that can be performed at step 9 of the process of FIG. 29.

FIG. 36 is a block diagram of the shutdown process that can be performed at step 10 of the process of FIG. 29.

FIG. 37 is a block diagram of the pneumatic system of the material handling machine of FIG. 1.

FIG. 38 is a block diagram of the hydraulic system of the material handling machine of FIG. 1.

FIGS. 39a and 39b are a block diagram of an overview of the control system of the material handling machine of FIG. 1.

FIGS. 40a and 40b are a supervisor box functional block diagram of the control system 3900 of the material handling machine of FIG. 1.

FIGS. 41a and 41b are a main electrical box functional block diagram of the control system of the material handling machine of FIG. 1.

FIGS. 42a and 42b are a power distribution box functional block diagram of the control system of the material handling machine of FIG. 1.

FIGS. 43a and 43b are a computer box functional block diagram of the control system of the material handling machine of FIG. 1.

### DETAILED DESCRIPTION

Material handling machines of the present technology can be used to bag various materials, such as sand, gravel, dirt, rocks, minerals, seeds, nuts, grains, foods, etc. In some examples, material handling machines of the present technology can be transported, deployed, and operated to provide sandbagging services in areas that are flooding or expected to flood, such as in severe weather including rain storms. In other examples, material handling machines of the present technology can be employed in pipeline construction, construction services supply, erosion control, and traffic control. Material handling machines of the present technology can provide production lines that can be used to fill bags with material, seal the filled bags, and collect the sealed bags for transportation to, or local storage at, a location in which the filled bags will be used.

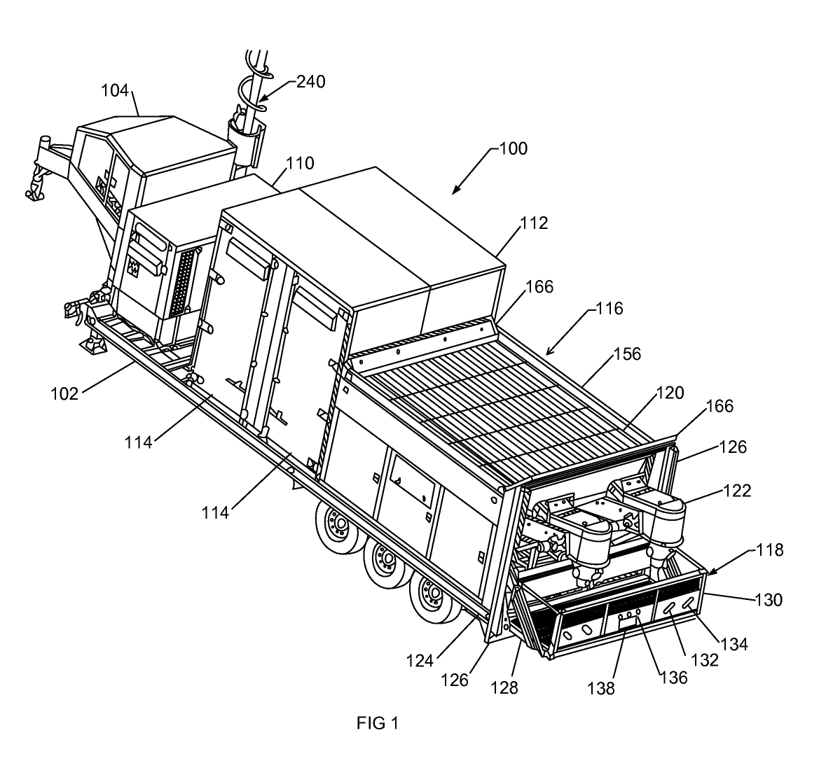

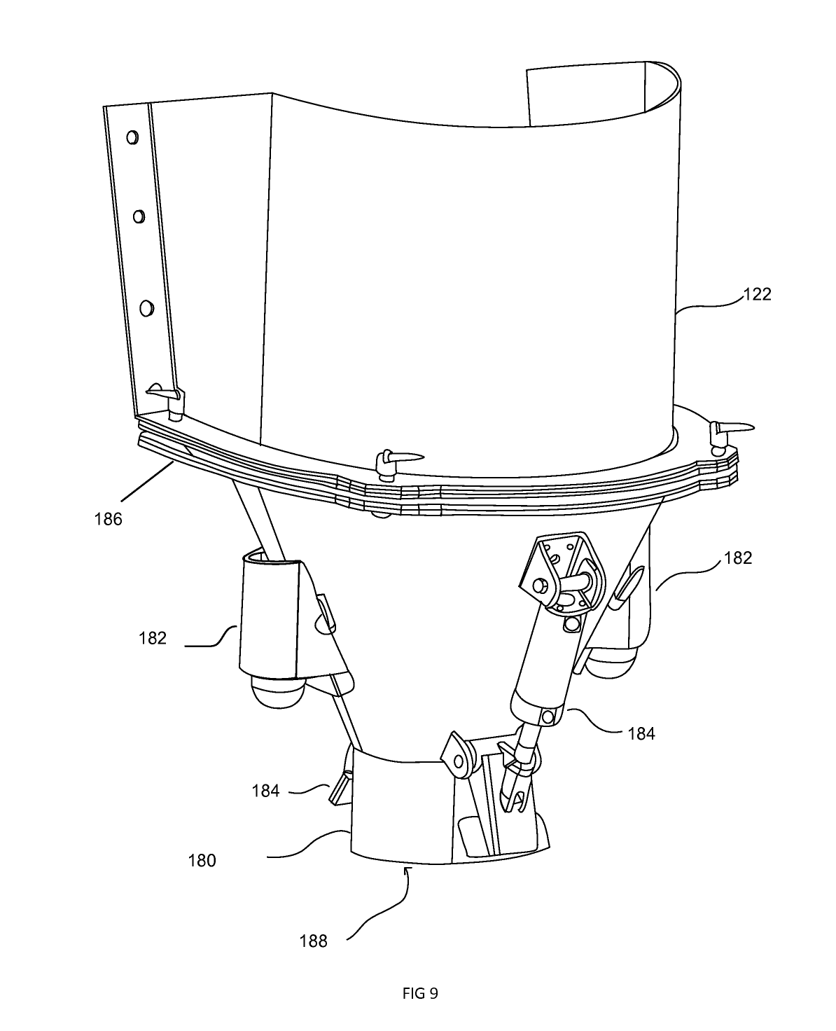

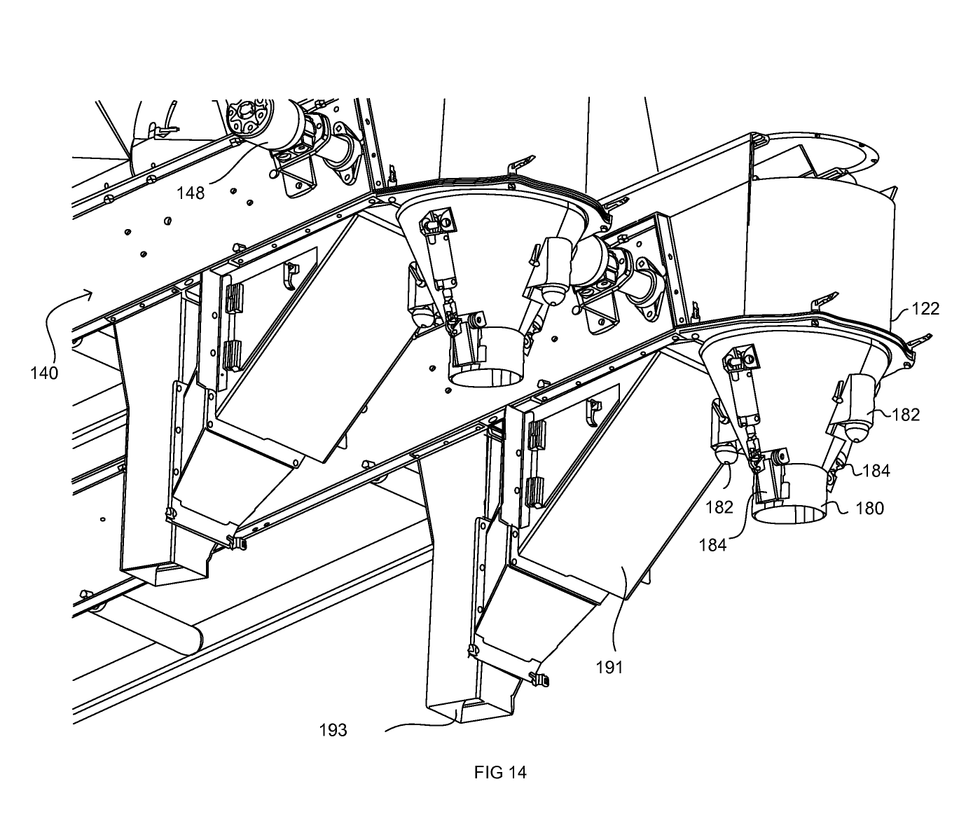

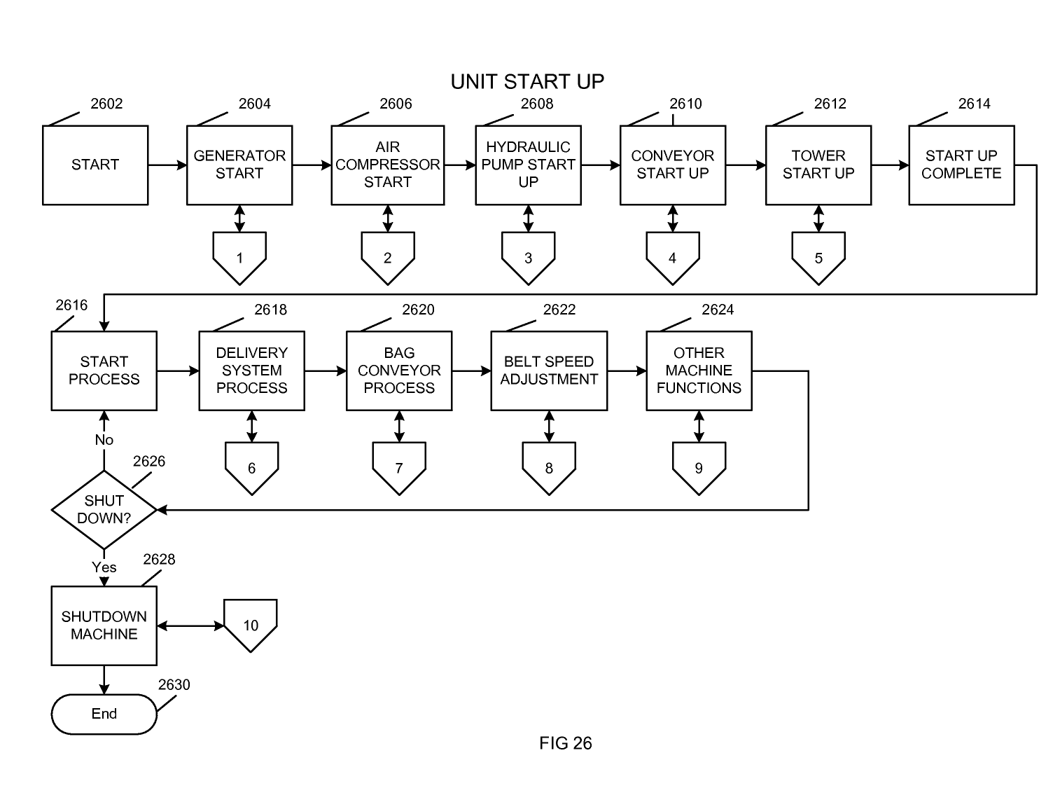

FIGS. 1-25 illustrate one example of a material handling machine 100 of the present technology, and FIGS. 26-39b illustrate various systems and processes that can be used to operate and control material handling machine 100.

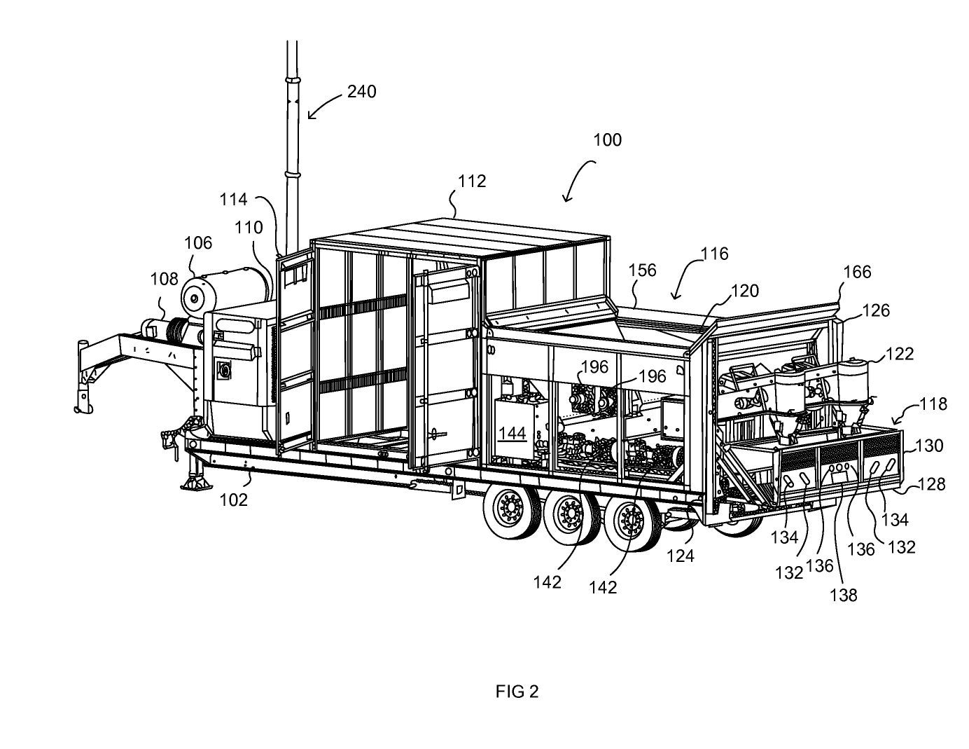

FIGS. 1 and 2 illustrate different views of the material handling machine 100, with FIG. 1 including covers over various components, and FIG. 2 showing the covers removed or opened.

The base 102 of the material handling machine 100 can be a trailer bed. The various components of the material handling machine 100 can be built onto, or otherwise mounted onto the base 102, and can be attached in either a permanent or detachable manner. The base 102 can be designed to be attached to and hauled by a road vehicle, such as a truck. In the illustrated example, the base 102 is a trailer bed that has a length that is 24 feet, although any suitable size can be used. Alternatively, components of material handling machine 100 can be transported on a trailer and offloaded at a site. In one example, components of material handling machine 100 can be stored in a container for transport.

The material handling machine 100 can include an air tank and compressor compartment 104, which can be attached to the base 102, which can house an air tank 106 and a compressor 108 that can provide air for pneumatically driven equipment on the material handling machine 100. The air tank and compressor compartment 104 can be attached to the base 102 at any suitable location, including for example at a front end of the base 102.

The material handling machine 100 can also include a diesel generator 110, which can be attached to the base to provide power to equipment on the material handling machine 100. The diesel generator 110 can be attached to the base 102 at any suitable location, including for example behind the air tank and compressor compartment 104 towards the front end of the base 102.

The material handling machine 100 can further include a storage compartment 112, which can be attached to the base 102. The storage compartment 112 can be used to store supplies, such as bags that get used during operation of the material handling machine 100. Additionally, or alternatively, the storage compartment 112 can be used as a shelter, office, or sleeping space for one or more people who operate the material handling machine 100. The storage compartment 112 can be insulated, and can be provided with air conditioning and/or heat. The storage compartment 112 can include one or more doors 114, and can also include one or more windows or skylights (not illustrated). In the illustrated example, the storage compartment 112 can be attached to the trailer bed 102 by twist locks, of a type that is known in the cargo container industry, and can be lifted and transported for installation or removal by a forklift. The storage compartment 112 can be attached to the base 102 at any suitable location, including for example at an intermediate location between the front end and the back end of the base 102, such as behind the diesel generator 110.

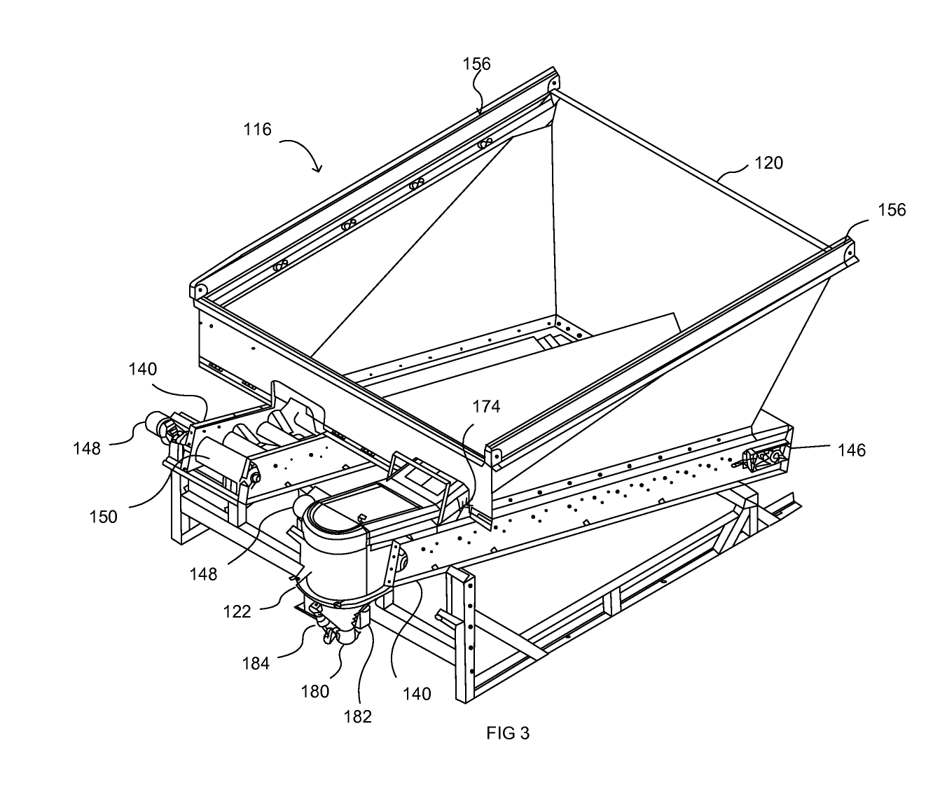

At or near the back end of the base 102, the material handling machine 100 can include a hopper and conveyor assembly 116 and a lift gate 118. The hopper and conveyor assembly 116 can be used to receive a material, such as sand, to be bagged, into the hopper 120, and convey it out of the hopper 120, through a chute 122, and into a bag. Various components of the hopper and conveyor assembly 116 are illustrated and discussed with reference to FIGS. 3-15 below. The air tank 106 and a compressor 108, and the generator 110 can be operatively connected to the hopper and conveyor assembly 116, and can provide pneumatic and electric power, respectively, to various components of the hopper and conveyor assembly 116.

The lift gate 118 can be attached to the back end 124 of the base 102, and can extend a distance from the back end 124. The lift gate 118 can be a rail type lift gate, having two vertical rails 126 upon which the platform 128 of the lift gate 118 can be raised and lowered. The platform 128 of the lift gate 118 can be fixed in an open position, and can be positioned beneath the chutes 122 of the hopper and conveyor assembly 116. The platform 128 of the lift gate 118 can allow for additional cargo space, and can also provide an adjustable work platform for use during operation of the material handling machine 100. For example, the height of the platform 128 can be adjusted up or down by raising or lowering the platform 128 on the rails 126, so that operators of the material handling machine 100 can elect to sit or stand as they work, so that the distance between the spout 180 of the chute 122 and the production conveyor 140 can be adjusted to accommodate bags of different lengths, or so that the descent angle of the material handling machine 100 can be adjusted when trying to place the machine in a work environment.

The horizontal standing surface of the platform 128 can be made of a grate, such as 1 inch aluminum grating, which can allow for material, such as sand, to pass through if it misses the bag or otherwise falls off the hopper and conveyor assembly 116 onto the platform 128.

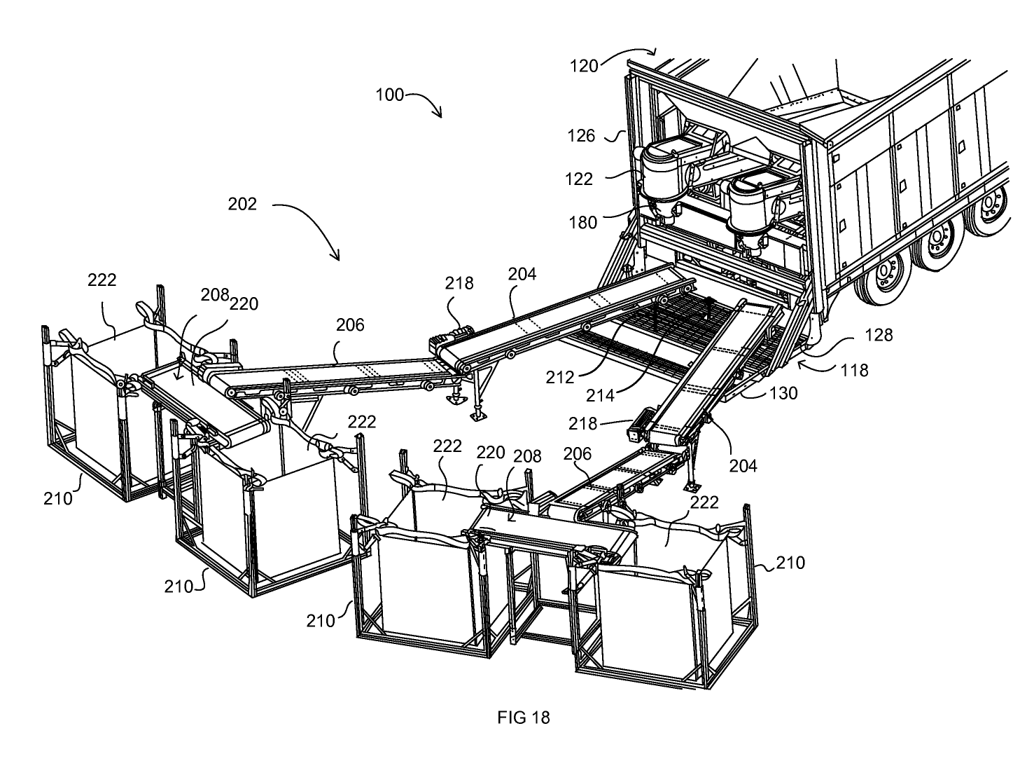

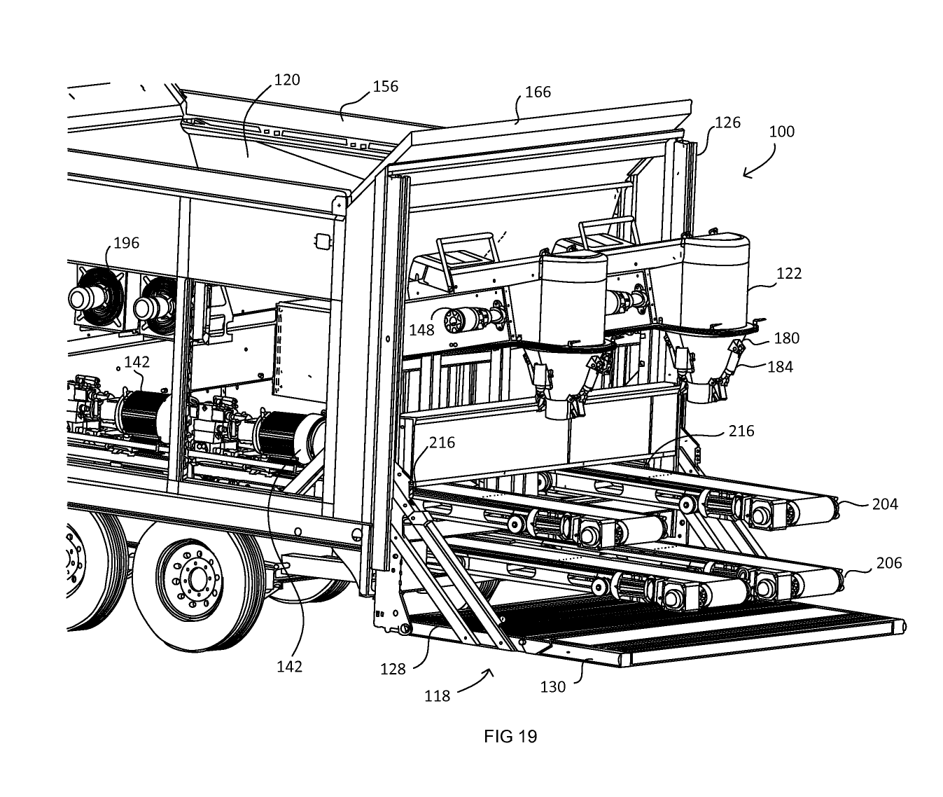

The lift gate 118 can include a fold down fence 130, which can be attached to the rear of the platform 128. The fold down fence 130 can include driving accessories, including for example, brake lights 132, turn signals 134, license plate lights 136, and a license plate mounting bracket 138. When the fold down fence 130 is in an upright position, it can function as the back of the material handling machine 100, and can act as a crash barrier that can protect at least some of the other components mounted near the rear of the base 102. When the fold down fence 130 is folded down and outward (see FIGS. 18 and 19), it can extend the platform 128 an additional distance, such as about 2 feet, providing more work space for the operators of the material handling machine 100. As with the horizontal standing surface of the platform 128, use of a grate as the fold down fence 130 can allow for material to pass through if it misses the bag or otherwise falls off the hopper and conveyor assembly 116 onto the fold down fence 130 when it is in a folded down position. Also, use of a grate as the fold down fence 130 can allow air to pass through when the fold down fence is in an upright position, which can reduce wind drag when the material handling machine 100 is being transported, such as being hauled by a truck.

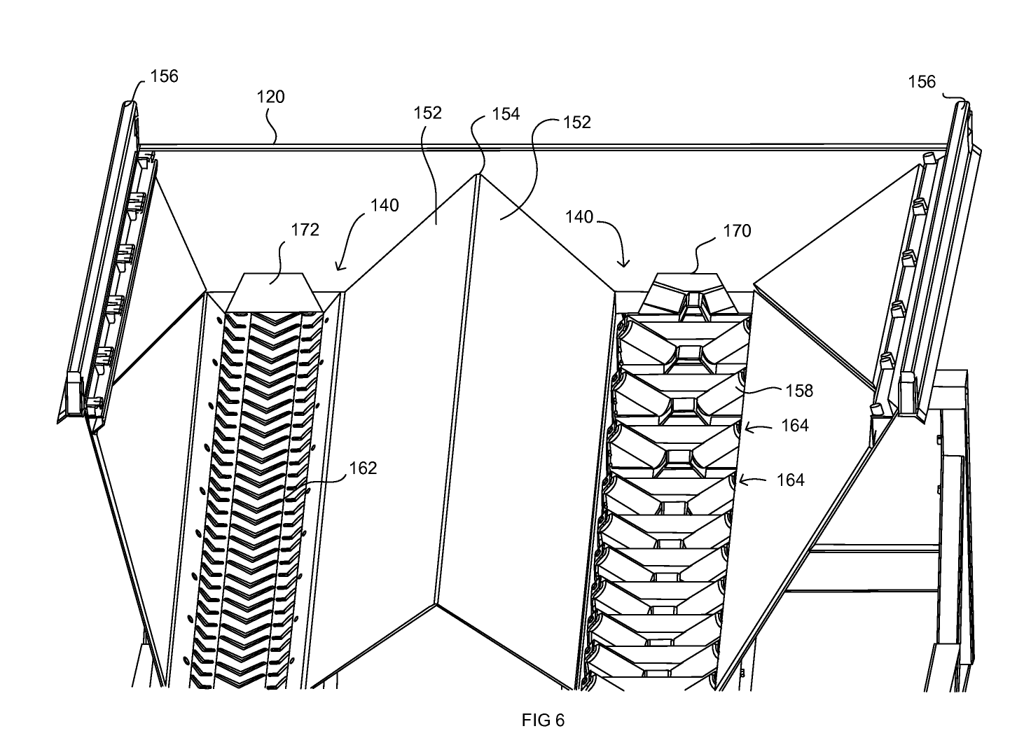

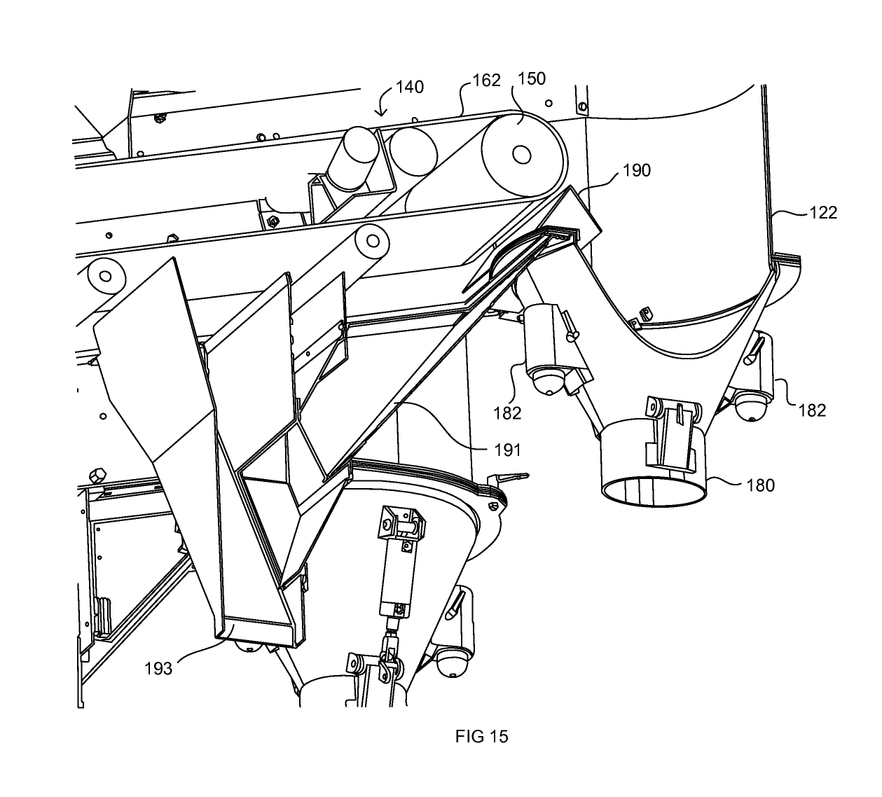

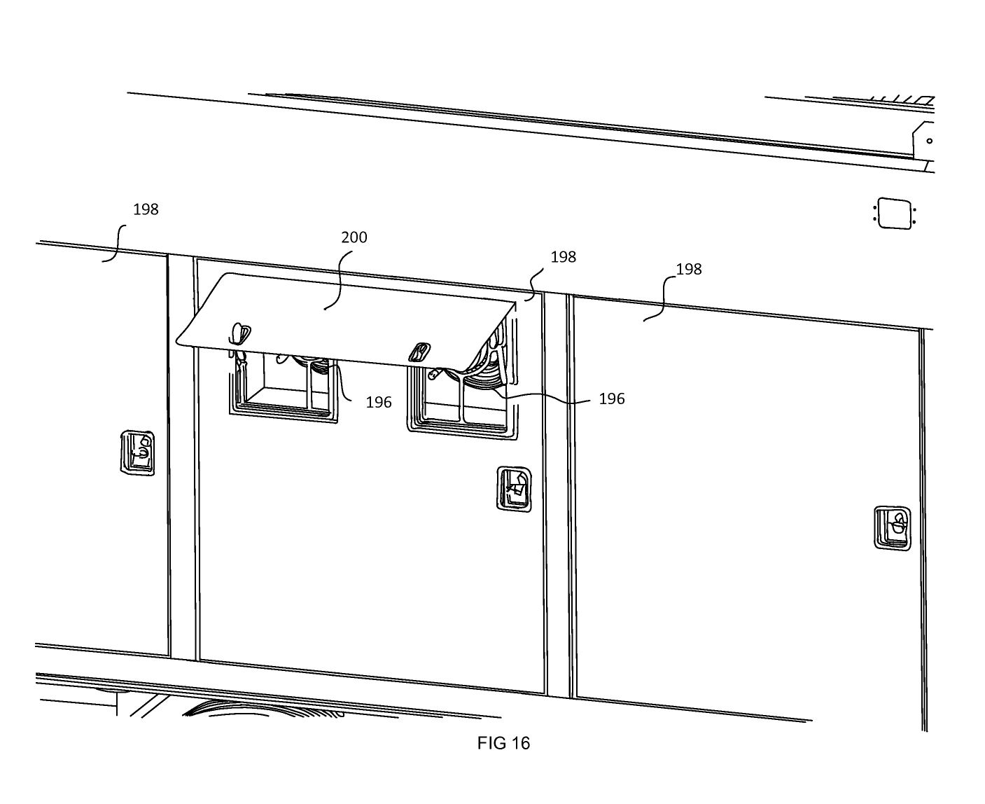

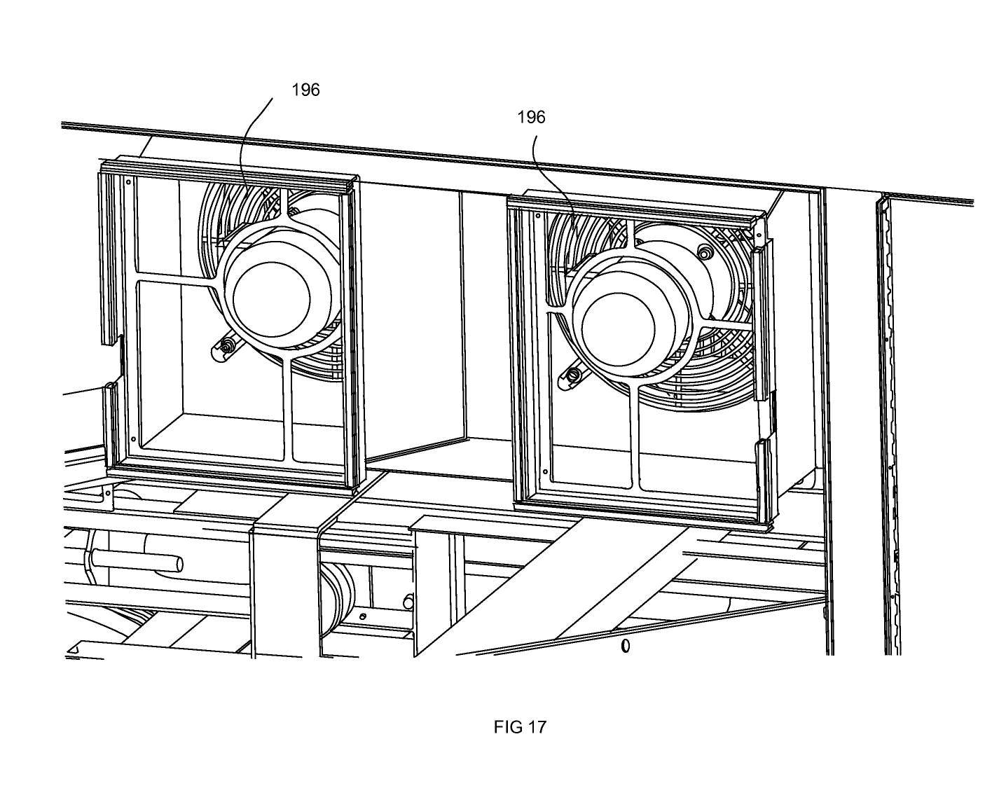

As can be seen in FIG. 2, where the panel covers have been removed, operational equipment can be placed underneath the hopper and conveyor assembly 116. The operational equipment can include two electric motors 142 (also shown in FIG. 19). Each electric motor 142 can be connected to one hydraulic pump. Each hydraulic pump can drive either of the conveyor belts 162 on the material conveyors 140 of the hopper and conveyor assembly 116 (see FIGS. 6 and 15). The operational equipment placed under the hopper and conveyor assembly 116 can also include a hydraulic filter and heater 144 for heating hydraulic fluid used by the material handling machine 100. The operational equipment placed under the hopper and conveyor assembly 116 can further include a radiator system, and two fans 196. Referring to FIGS. 16-17, there can be three cover panels 198 that cover the operational equipment placed under the hopper and conveyor assembly 116. The middle cover panel 198 can have a hatch 200 in front of the fans 196, which can be lifted to allow the fans 196 to vent air to the outside. The radiator system can include two hydraulic fluid coolers, one connected to each material conveyor 140, that each maintain the operating temperature when the ambient temperature rises. The fans 196 on the hydraulic fluid coolers pull the air through the radiator and vent it outside through the hatch 200. When the material handling machine 100 is not in use, the hatch 200 can be closed and locked.

FIG. 3 shows a hopper and conveyor assembly 116, which includes two material conveyors 140 that each convey material, such as sand, out of a hopper 120, and into a chute 122, although the chute 122 of the left material conveyor 140 is not shown in FIG. 3. The hopper 120 can be filled from the top using a loader or one or more conveyors that deliver the material, such as sand, to the top of the hopper 120.

In the illustrated example, the material conveyor 140 are not placed in a manner that is symmetrical with respect to the centerline of the hopper 120, or with respect to the centerline of the base 102. Instead, as shown, the two material conveyors 140 are offset to one side, in this instance the right side, of the hopper 120, and of the base 102. Such an offset arrangement of the material conveyors 140 can provide additional workspace on the opposite, or left, side of the material handling machine 100, and can also provide additional space under the left side of the hopper 120 for dual hydraulic systems to be placed closer to the drive motors of the material conveyors 140. Additionally, while the hopper 120 can be loaded from either side of the material handling machine 100, this arrangement can be conducive to designating the right side of the material handling machine 100 to be the side at which the filling equipment is located, and for safety, workers can be directed to work from the left side.

Each material conveyor 140 can include a tension adjuster 146, to adjust the tension of the belt of the material conveyor.

Each material conveyor 140 can also have a hydraulic motor/sensor assembly 148, which can be located on a central axis of a first roller 150 of the material conveyor 140. The sensor portion of assembly 148 can measure the rotation of the first roller 150 and calculate a distance that the belt has traveled based on the amount of rotation of the first roller 150. In the illustrated example, a gear sprocket is mounted on the roller shaft, and a proximity sensor is placed in proximity to the sprocket teeth, which creates an encoder that controls the distance, or length, the conveyor belt 162 (shown in FIG. 6) travels before it stops.

The hopper 120 can have an upper cross section that is a quadrangle, such as a rectangle or a square, which can have two sides and two ends, or can have any other shape suitable for receiving material loaded into the top of the hopper 120. As shown in FIGS. 3 and 6, the hopper 120 can include trough panels 152, which can extend upwardly at an angle from spaced points at the bottom of the hopper 120, and meet in a peak 154 between the material conveyors 140 at a height below the total height of the hopper 120. The trough panels 152 can divert material towards the material conveyors 140 as it is loaded into the hopper 120. The angle of the trough panels can be any suitable angle, including for example, about 45° or greater.

As shown in FIGS. 1-3 and 6, the hopper 120 can have bang boards 156, which are sacrificial wooden boards, mounted along the top edge of each side of the hopper 120. The bang boards 156 can extend the entire length of the hopper 120. In the illustrated example, the boards can be about 2 inches wide, 6 inches tall, and ten feet long. The bang boards 156 can provide some protection for the side of the hopper 120, such as from potential damage from the bucket of a loader that loads material into the hopper 120. The bang boards 156 can also act as a back stop, catching rocks and clumps from falling off the side of the hopper 120.

As also shown in FIGS. 1-2, the hopper 120 can have diverter panels 166 mounted along the top edge at each end of the hopper 120. The diverter panels 166 can extend the entire width of the hopper 120. The diverter panels 166 can extend from the end of the hopper 120 at an upward angle, such as an angle of about 45° or greater. The diverter panels 166 can provide a wide chute lead-in to the hopper 120, allowing a larger loader with a wider bucket, such as up to 140 inches for the illustrated example, to load material into the hopper 120 without spilling over the ends.

In the illustrated example, the hopper 120 is rectangular in shape at the top, and was a width that is about 101 inches, corresponding to the width of the trailer base 102, and a length that is about 120 inches along the side of the trailer base 102. The vertical edge of the hopper 120, including the bang board, has a height of about 102 inches as measured from ground level, which includes the height of the base 102. The material can be gravity fed to both material conveyors 140 simultaneously. Use of a single hopper 120 for feeding material to two material conveyors 140, and two production lines can allow the material handling machine 100 to be more compact, while requiring less labor to keep the hopper 120 charged.

In examples such as the illustrated example, where the material being used in the material handling machine is sand or some other material that will get into every crack and crevice if allowed to do so, the entire inside of the hopper 120 can be lined and sealed. For example, the inside of the hopper 120 can be lined with ½ inch thick UHMW (ultra high molecular weight) polymer sheet, which includes a percentage of silicon in the formulation. The seams can be sealed with high grade silicon sealant. Additionally, the panels of the hopper 120 can be held in place with elevator bolts that create a smooth even surface for the material to slide on.

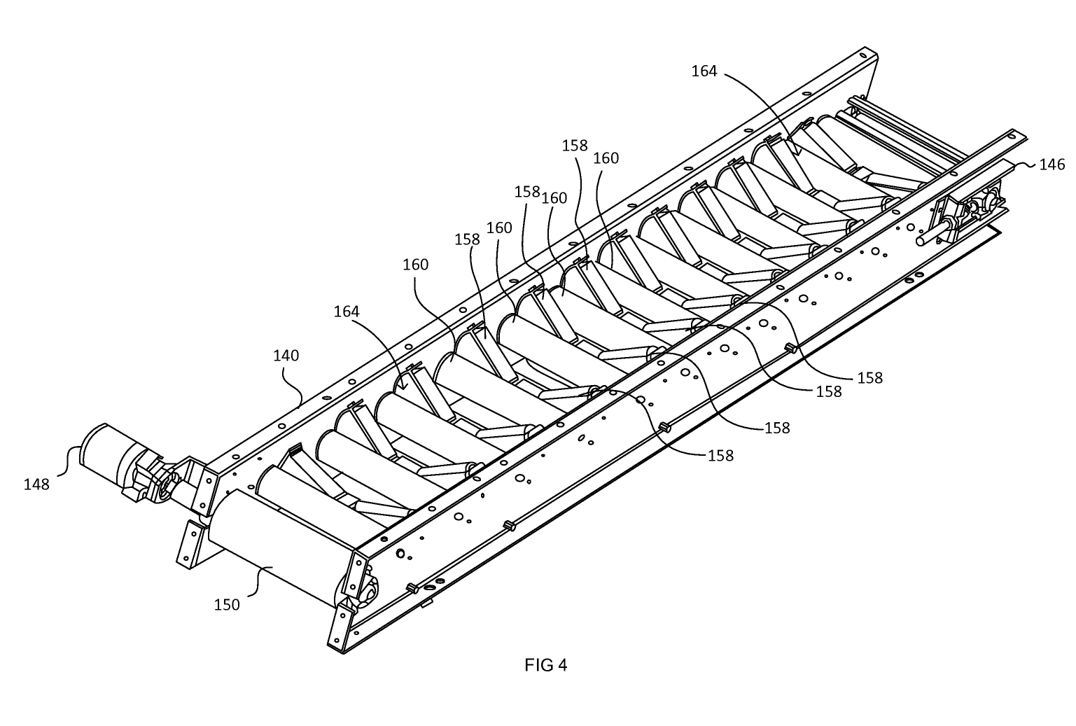

Referring to FIGS. 4 and 6, each material conveyor 140 includes a plurality of roller modules 164 located underneath the conveyor belt 162 (shown in FIGS. 6 and 15). Each roller module includes two angled trough rollers 158 and one horizontal load roller 160 that are arranged to direct material towards the center of the material conveyor 140. For example, as material weighs down the conveyor belt 162, the belt will rest on the roller modules 164, thus conforming to the angle of the two angled trough rollers 158 and being supported underneath by the horizontal load roller 160. In the illustrated example, the roller modules 164 angle the outer edges of the belt 162 upward at an angle of about 35° for nearly the entire length of the conveyor. However, the first and last roller modules 164 on the material conveyor 140 are angled at about 20°, which can provide a more gradual angle of approach and decent of the belt as it approaches the pulley at each ends of the material conveyor 140. The modular construction of the rollers can allow for fast and easy removal of one or more modules 164, which can provide full access to any and all rollers that would otherwise be buried and difficult to change.

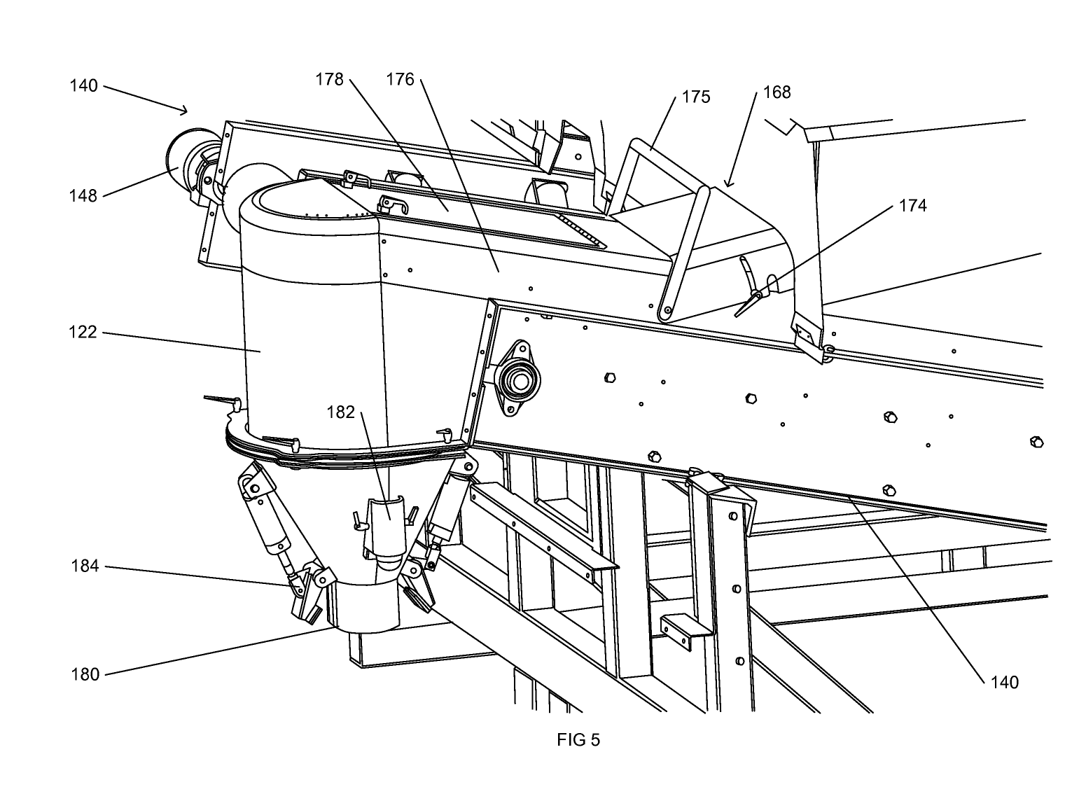

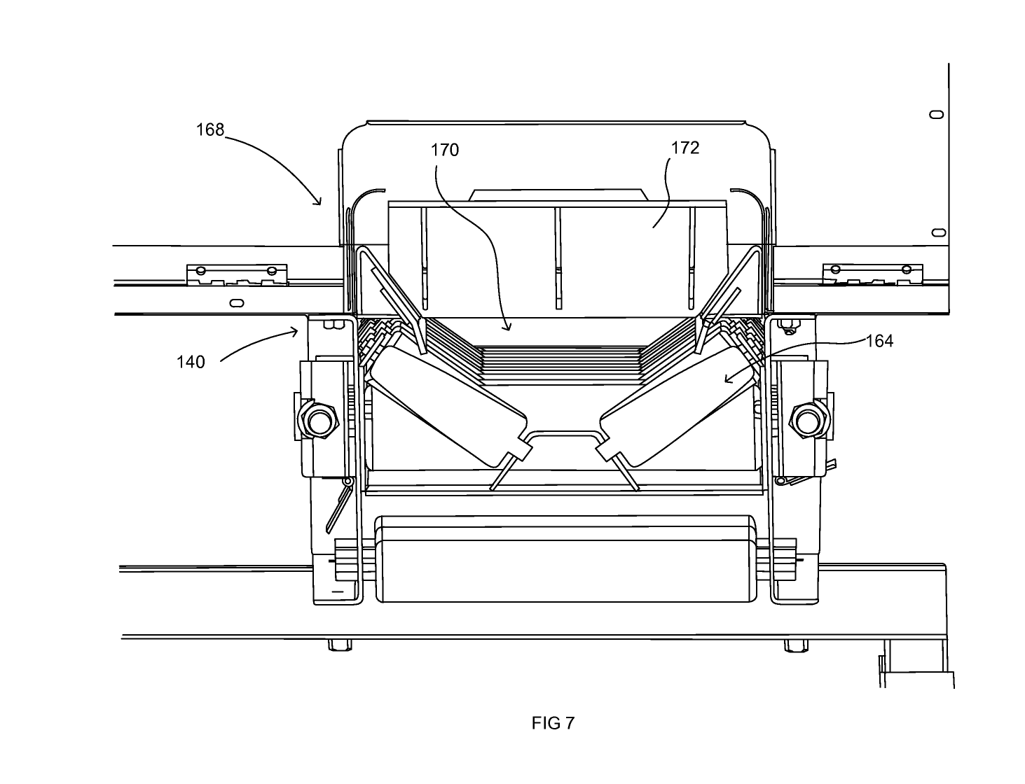

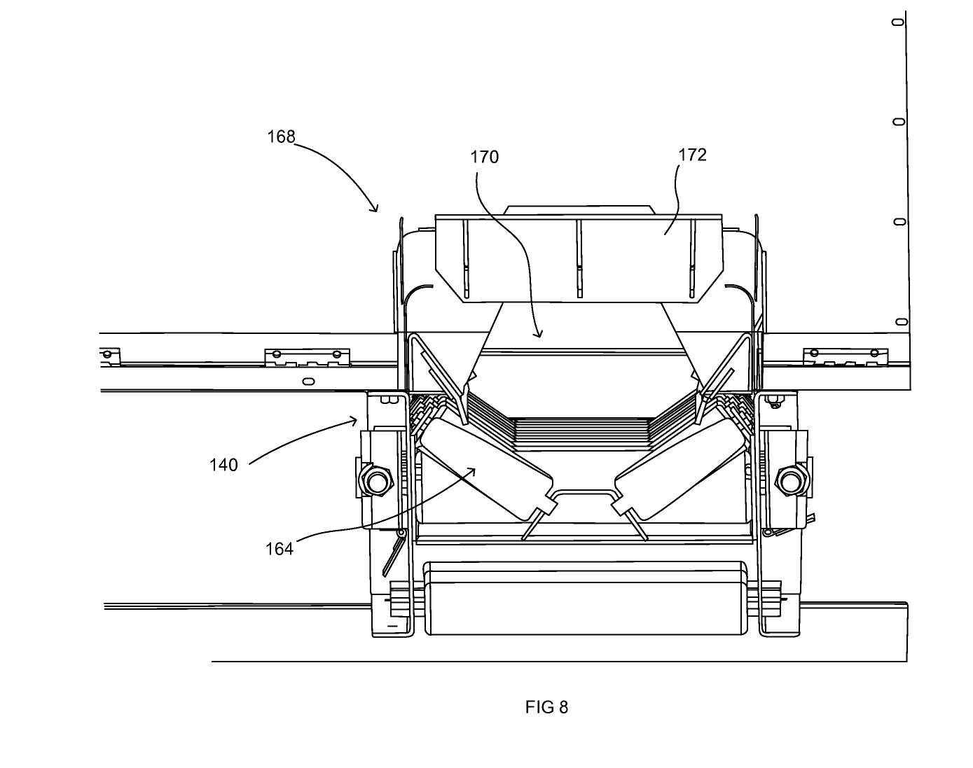

Referring to FIGS. 5-8, a chute 122 is provided at the end of each material conveyor 140. At the entrance to each chute 122, a material flow gate 168 includes a gate opening 170, gate flap 172 and a gate handle 175 and a gate lock 174. The material flow gate 168 shapes and meters the cross sectional area of the material that is being forced through the gate opening 170. The material flow gate 168 can be located against the rear wall of the hopper, just above the belt 162 of each material conveyor 140. The size of the gate opening 170, and thus the cross sectional area of the material flow gate 168, can be adjusted by adjusting the height of the gate flap 172. The height of the gate flap 172 can be adjusted by rotating the gate handle 175 and locking it in position with the lock 174. The height of the gate flap 172 can be adjusted to any height from fully closed, as shown in FIG. 7 and the left conveyor in FIG. 6, to fully open as shown in FIG. 8 and the right conveyor in FIG. 6. The higher the gate is opened, the more material is allowed to flow through it. The cross sectional area of the gate can thus be varied, and can be determined based upon the height of the gate flap 172.

In the illustrated example, the gate opening 170 of the material flow gate 168 is wider at the bottom and narrower at the top due to having inward sloping sides. The sloped sides can help minimize slump, or collapsing of loose material as the pile of material moves along the material conveyor 140 through the material flow gate 168 into the volume chamber 176.

The volume chamber 176 extends from the material flow gate 168 to the end of the material conveyor 140, and has a height that is taller than the height of the gate opening 170 when the gate flap 172 is fully open. In the illustrated example, the volume chamber 176 can be at least 28 inches long. The volume chamber 176 can be closed on all sides to minimize dust seepage. There can be a volume chamber door 178 located at the top of the volume chamber 176, which can also extend over at least a portion of the chute 122, and can provide a viewing port to allow an operator to look into the material flow gate 168, volume chamber 176 and the chute 122.

During operation of the material handling machine 100, as the material is extruded through the gate opening 170 of the flow gate 168, it is shaped into a long uniform pile. The shaped pile of material then travels on the conveyor belt 162 through the volume chamber 176 to the end of the material conveyor 140. Further advancement of the conveyor belt 162 of the material conveyor 140 causes the material at the end of the material conveyor 140 to fall into the chute 122, through the spout 180, and into an open bag at the bottom of the spout 180.

The volume of the material that is dispensed into a bag can be determined by controlling both the distance that the conveyor belt 162 of the material conveyor 140 advances and the height, thus also the cross sectional area, of the gate opening 170 of the flow gate 168. The material handling machine 100 can be programmed with preset parameters that can be selected for controlling the distance that the conveyor belt 162 advances before stopping, based on a desired volume of material to be dispensed into each bag. The volume of material dispensed into each bag can also be varied by adjusting the height of the gate opening 170 for the flow gate 168. Alternatively, the operator can adjust the settings manually by changing the height of the gate opening 170 of the flow gate 168 or incrementally adjusting the distance that the conveyor belt 162 advances before stopping.

Referring to FIGS. 5, 9-10, and 14, a spout 180 can be attached to and extend beneath the chute 122. The spout 180 can have a funnel shape, having a top opening 186 where it attaches to the chute 122 that is wider than a bottom opening 188 through which material exits the spout 180 into a bag. In at least some examples, the bottom opening 188 of the spout 180 can be smaller than the opening of the bag to be filled. In at least some examples, a spout 180 can be removed or replaced as desired, and can be rotated to any angle to accommodate different operator, and filling requirements. Additionally, spouts of different shape or size can be used to accommodate the different bag sizes and/or fill material characteristics.

The spout 180 can include at least one proximity detector 182 to detect the presence of an operator's hand, and at least one bag clamp 184. The at least one bag clamp 184 can be pneumatic. The at least one proximity detector 182 can be adjustable in height, and preferably are not sensitive to sun light or inclement weather, although an operator's hands need not touch the sensor for it to sense the proximity of the operator's hands. In the illustrated example, the spout 180 includes two proximity detectors 182, one on either side of the spout 180, and two bag clamps 184, one on the front side and one on the back side of the spout 180. Thus, as shown, the bag clamps 184 are located 180° apart and are each positioned 90° around the circumference of the spout 180 from a proximity detector 182.

The at least one proximity detector 182 can be used to control the closing of the at least one bag clamp 184. For example, when an operator picks up a bag from a stack near the operator, the operator can grasp the open side of the bag with both hands, one on each side with at least one finger on each hand placed within the bag to help spread it open. The operator can place the bag under the end of the spout 180, sliding the end of the bag upward over the bottom end of the spout 180 until the proximity detectors 182 detect both hands are within the proximity of the sensors, which in-turn triggers the pneumatic bag clamps 184 to close on the bag. When the bag clamps 184 close, the control system of the material handling machine 100 can cause the hydraulic motor 148 to advance the conveyor belt 162 of the material conveyor 140 the predetermined distance to dispense the selected volume of material into the bag. As soon as the bag is clamped, the operator is free to release the bag and grab another. When the bag is full, as determined by the belt 162 stopping after traveling the predetermined distance, the bag clamps 184 can automatically release, and the bag can fall onto a moving production conveyor, shown in FIG. 18.

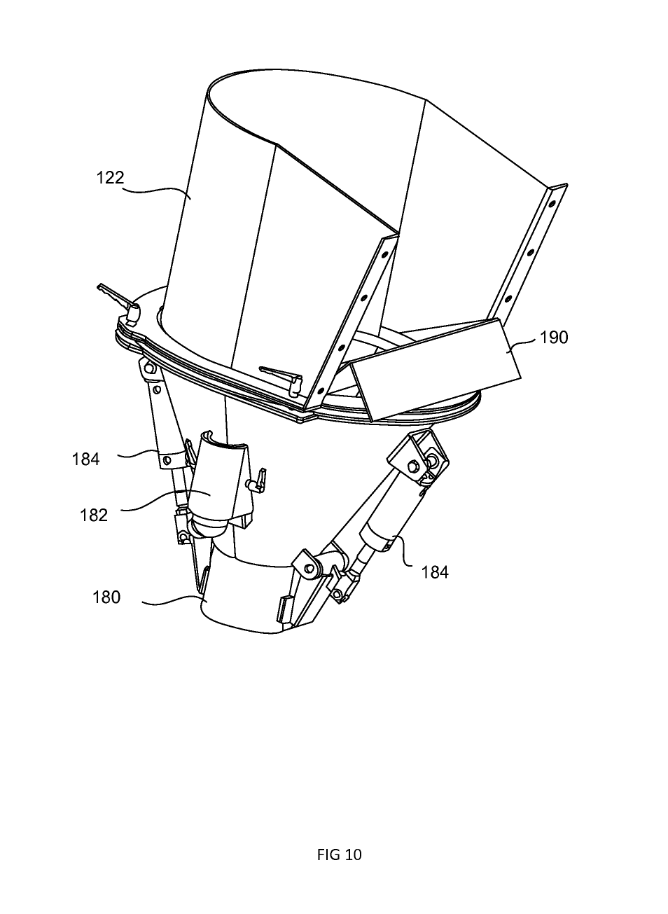

Referring to FIGS. 10, 14 and 15, a scraper 190 can be attached to the chute 122 so that it comes close to a surface of belt 162 after belt 162 has gone around roller 150 and starts to return to the hopper 120. The scraper 190 can be used alone, or in conjunction with a brush, to remove sand from the belt 162 and have the sand fall into the bag. Sand removed by the scraper 190 can fall into chute 122 or into chute 191. The sand on chute 191 can slide through opening 193 into a collection device such as a wheel barrow.

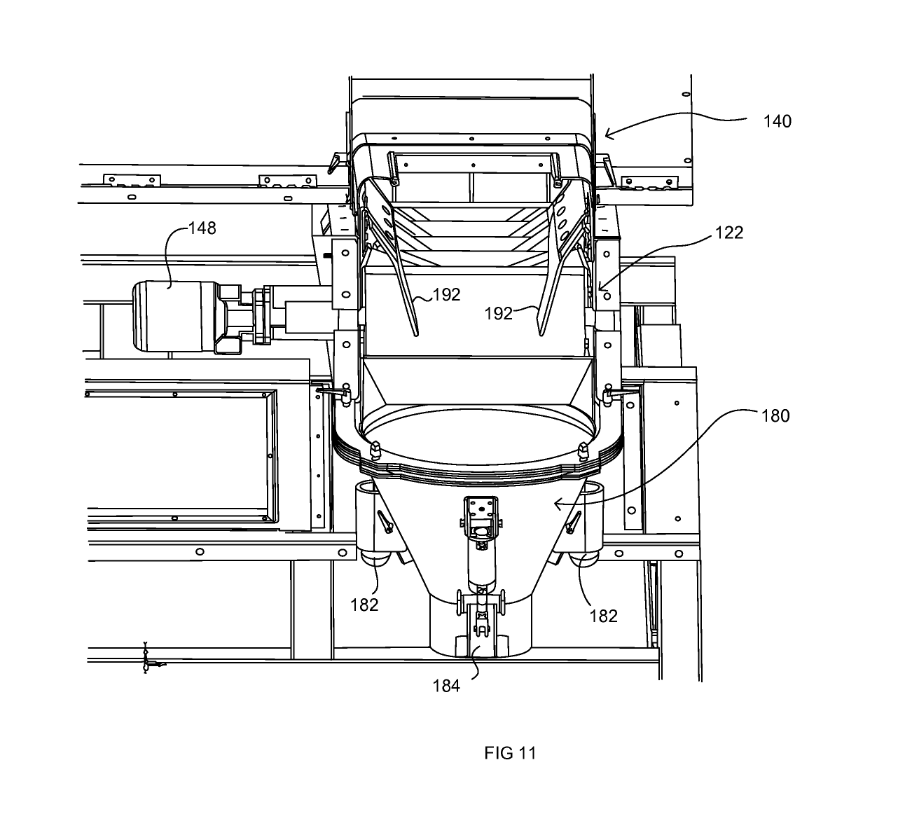

Referring to FIG. 11, the chute 122 can include guides 192, which can extend downwardly into the chute 122 at an angle to guide material towards the center of the chute 122.

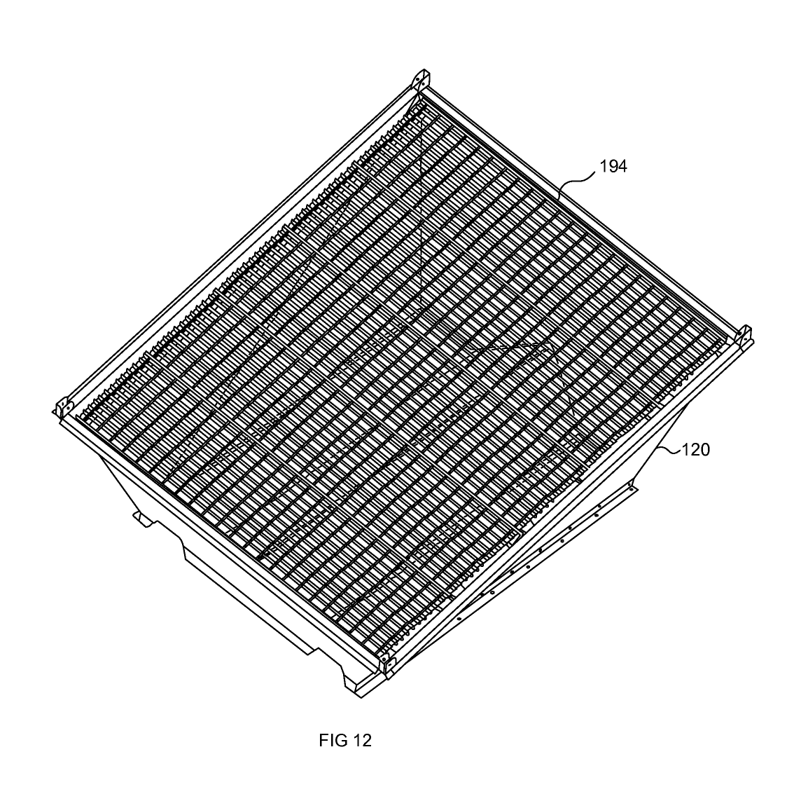

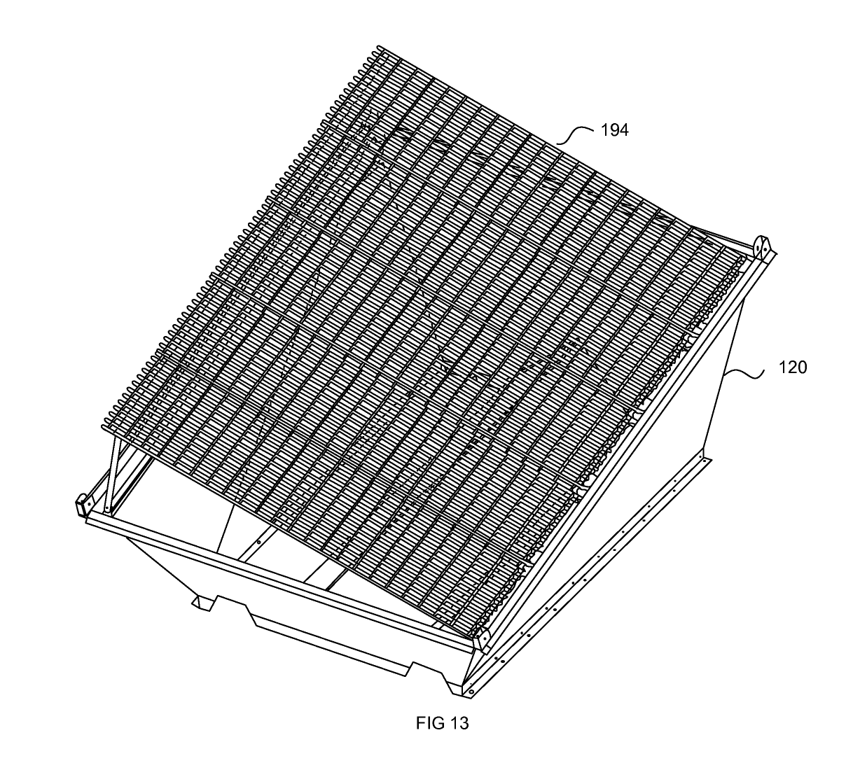

Referring to FIGS. 12-13, the hopper 120 can include a cover grate 194. The cover grate 194 can have a lowered position, as shown in FIG. 12, and a raised position, as shown in FIG. 13. The cover grate 194 can be used as a filter for the material being loaded into the hopper, where any clumps or extraneous materials too large to fit through the openings of the cover grate 194 will not fall through the cover grate 194 and thus be prevented from entering the hopper 120. Cover grates 194 having different sized openings can be used for different materials and applications. Alternatively, cover grate 194 can be eliminated.

When in use, the material handling machine 100 can be configured as shown in FIG. 18, with the production line 202 in an operation position. The production line 202 can include two production conveyors 204, one extending from each chute 122. The production line 202 can also include two inclined conveyors 206, one extending from each production conveyor 204. The production line 202 can further include two shuttle conveyors 208, one at the end of each inclined conveyor 206. Additionally, the production line 202 can include a storage sack stand 210 at each end of every shuttle conveyor 208, which in the illustrated example is a total of four storage sack stands 210. In the illustrated example, each production conveyor 204 and each inclined conveyor 206 can be about 10 feet long.

Referring to FIG. 19, each production conveyor 204 and each inclined conveyor 206 can be stored on open frame rails 216 that retain the conveyors 204 and 206 within the framework of the base 102. Each production conveyor 204 and each inclined conveyor 206 can be accessible from the back end of the material handling machine 100 when the fold down fence 130 is in its folded down position.

Referring back to FIG. 18, when the production line 202 is in an operation position, the fold down fence 130 can be in its folded down position. Additionally, each production conveyor 204 can be attached to the platform 128 by at least one post 212, which can include a threaded rod and screws to allow the height of the proximal end of the production conveyor 204 to be adjusted up and down. Further, a seat post 214 can be attached to the platform 128, which can receive a seat for an operator to sit on.

During operation, a filled bag is dropped onto a production conveyor 204 when the a least one bag clamp 184 releases. The production conveyor conveys the filled bag to a sewing station 218, located at the distal end of the production conveyor 204. At the sewing station 218, each filled bag can be sewn closed and can be transferred to an inclined conveyor 206. The inclined conveyor 206 conveys a filled closed bag upwards at an angle to a shuttle conveyor 208. Each shuttle conveyor is 208 is positioned crossways, such as at a 90° angle, with respect to the inclined conveyor 206. The shuttle conveyor belts can be reversible, and can convey filled closed bags to either of two storage sacks 222, which are each held by a storage sack stand 210 at an end of the shuttle conveyor 208.

In examples such as the illustrated example, where the material handling machine 100 includes two chutes 122, and thus the production line 202 has two sides, each side of the production line 202 can be set up to run different size bags at different intervals. Additionally, if an optional divider is placed in the hopper 120 between the two material conveyors 140, each side of the production line 202 can be configured to run different materials at the same time while maintaining separate conveyor lines and inventory control requirements.

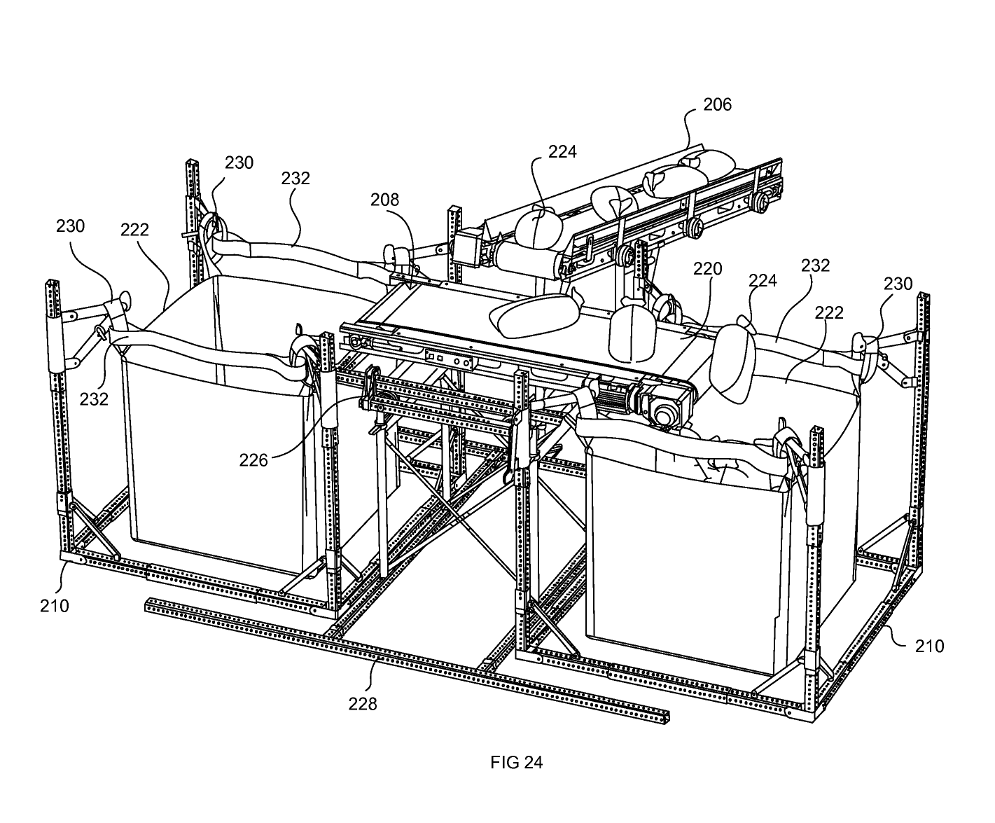

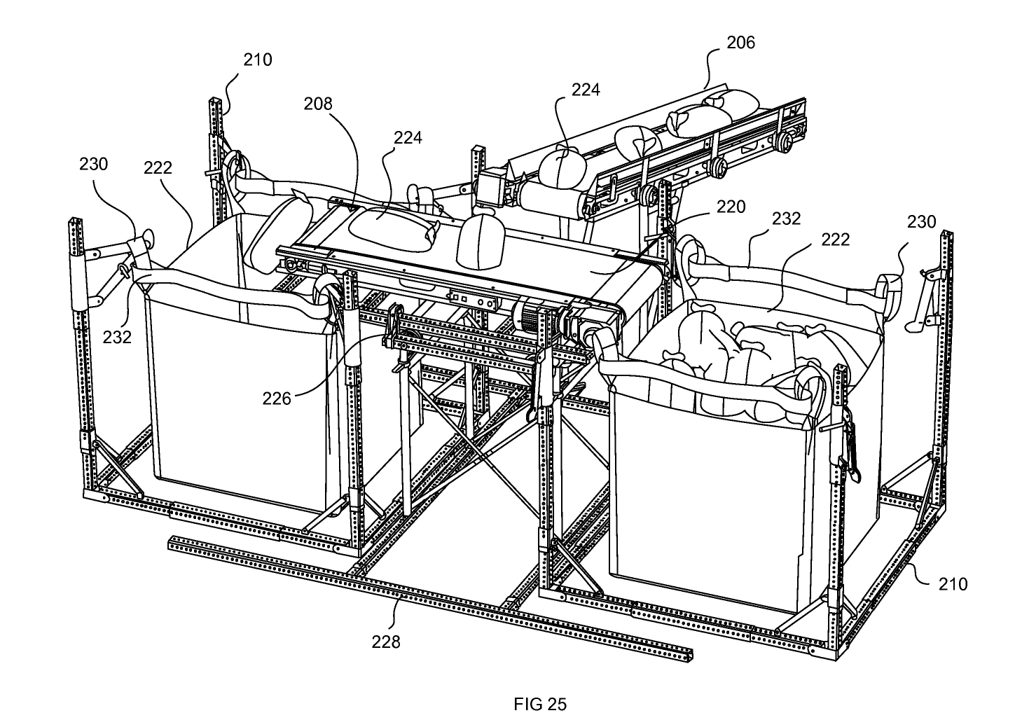

Referring to FIGS. 24 and 25, filled closed bags 224 can be conveyed on an inclined conveyor 206, and can be transferred to a shuttle conveyor 208. FIG. 24 shows the shuttle conveyor belt 220 moving to the right, and the filled closed bags 224 are thus conveyed to the right and into the storage sack 222 supported on the storage sack stand 210 located at the right end of the shuttle conveyor 208. As shown in FIG. 25, once the storage sack 222 on the storage sack stand 210 located at the right end of the shuttle conveyor 208 is full, or has received a predetermined number of filled closed bags 224, the shuttle conveyor belt 220 reverses direction and travels to the left, thus conveying filled closed bags 224 to the storage sack 222 supported on the storage sack stand 210 located at the left end of the shuttle conveyor 208.

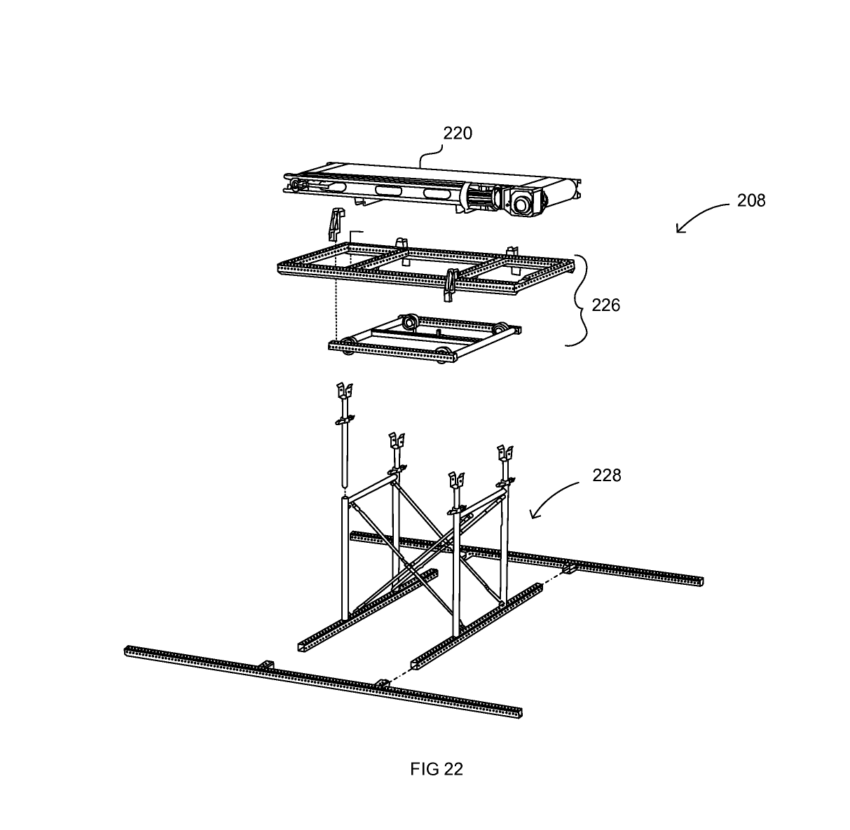

Referring to FIGS. 22 and 24-25, each shuttle conveyor 208 can include a reversible conveyor belt 220 attached to a trolley 226 that is secured to a stand 228. The trolley 226 can shift the reversible conveyor belt 220 from side to side, such as to the left or the right, so that each end of the reversible conveyor belt 220 can extend over and shift across the interior of a storage sack 222. FIG. 24 shows the reversible conveyor belt 220 shifted to the right by the trolley 226 while the storage sack 222 at the right end of the shuttle conveyor 208 is being filled, and FIG. 25 shows the reversible conveyor belt 220 shifted to the left by the trolley 226 while the storage sack 222 at the left end of the shuttle conveyor 208 is being filled. The action of the trolley 226 can be controlled manually or electronically.

As can be seen in FIGS. 24-25, each storage sack 222 can include loops 230, which can be used to secure the storage sack 222 to a storage sack stand 210. The loops 230 can also act as lifting points for moving the filled storage sacks 222. A Stevedore strap 232 can extend between a set of loops 232 along each side of the storage sack 222. The Stevedore straps 232 can provide an easy and quick lifting point for a fork lift or single hook loader to pick up a fully loaded storage sacks 222.

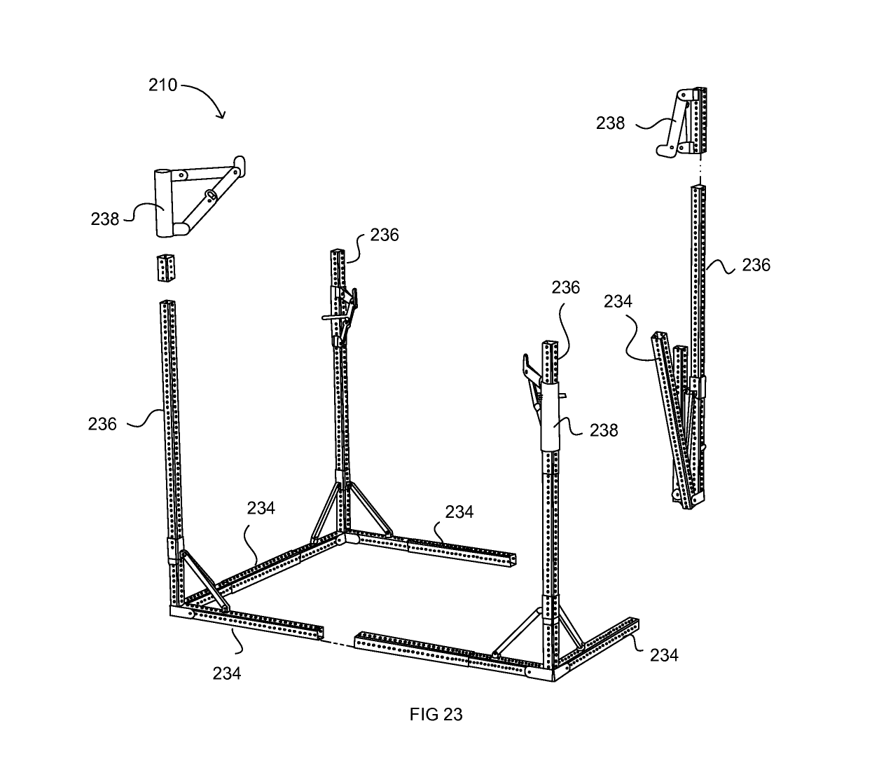

Referring to FIGS. 23 and 24-25, the storage sack stand 210 can include a folding and adjustable frame, which, can hold storage sack 222 wide open while the shuttle conveyor 208 feeds filled closed bags 224 into its cavity. Each storage sack stand 210 can include a plurality of horizontal braces 234 which can slidably mate with each other so that the length and width of the storage sack stand 210 can be adjusted. Each storage sack stand 210 can also include a plurality of vertical braces 236, which can include at least two slidably mated portions so that the height of the storage sack stand 210 can be adjusted. At least two horizontal braces 234 can be foldably attached to each vertical brace 236, and can fold upwardly to rest along the vertical brace 236 during storage and transport. Each storage sack stand 210 can further include a plurality of hangers 238 that can each be slidably received by a vertical brace 236. The loops 230 of a storage sack 222 can be secured to the hangers 238 when the storage sack 222 is placed onto the storage sack stand 210.

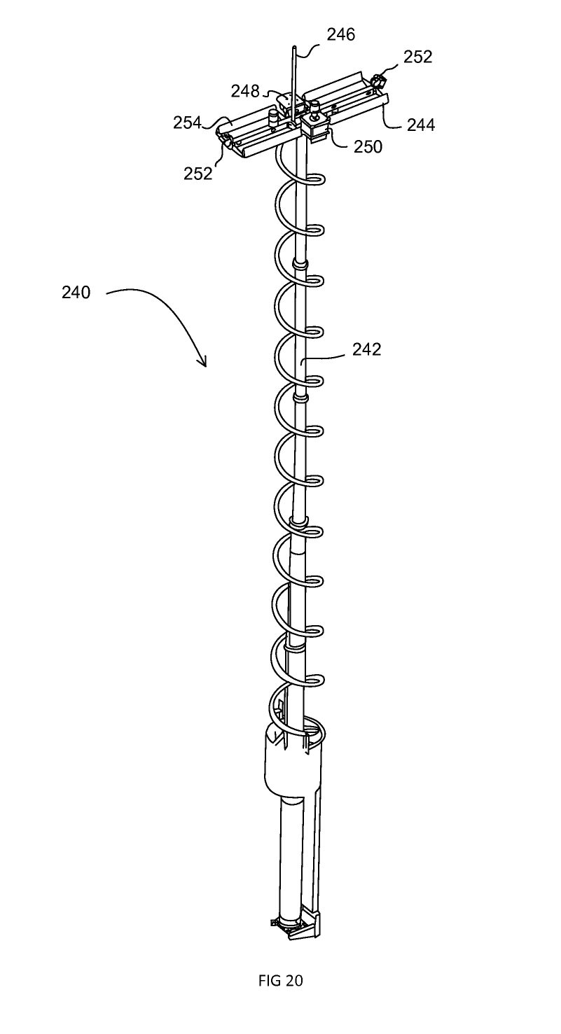

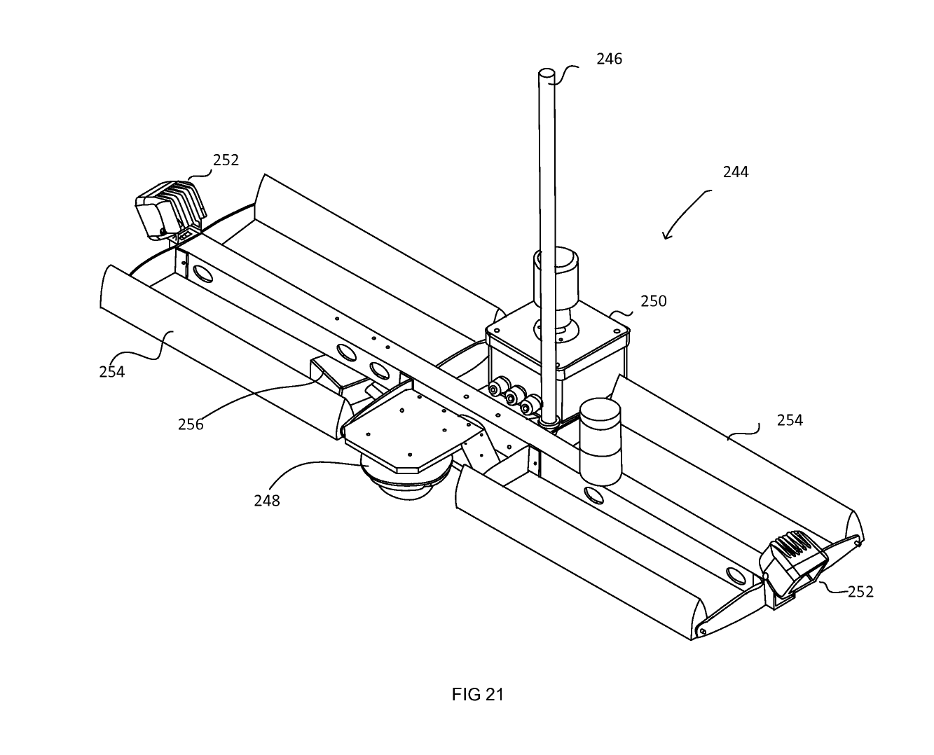

Referring to FIGS. 20-21, the material handling machine 100 can include a tower 240 attached to the base 102, which can include a shaft 242 and a head 244. The shaft 242 of the tower 240 can be pneumatically raised and lowered. The head 244 of the tower 240 can include a plurality of devices.

For example, the head 244 of the tower 240 can include cellular antenna 246, which can allow the monitor and control systems of the material handling machine to be operated and monitored remotely, such as from a network operations center (NOC) that may remotely monitor and/or control a plurality of material handling machines 100. In addition, the cellular antenna 246 may be employed to monitor local conditions in the vicinity of material handling machine 100, such as, for example, from weather station 250 and camera 248, discussed below.

The head 244 of the tower 240 can also include a camera 248, such as a video camera, which can be used to monitor the material handling machine and the area surrounding the material handling machine 100, and a weather station 250, which can monitor aspects of the weather such as wind speed, wind direction, temperature and atmospheric pressure, and can be used to warn operators of the material handling machine 100 when the weather becomes a danger to their operations. For example, if the weather station 250 measures wind speeds up to about 30 or 40 miles per hour, operators and other personnel in the vicinity of the material handling machine 100 may be instructed to vacate the area.

The head 244 of the tower 240 can further include at least one light 252, which can point longitudinally outward to shine light along the length of the head 244, as well as reflectors 254 that can include light bars, such as light emitting diodes (LEDs), and shine light downwardly onto and around the material handling machine 100. In one example, the head 244 of the tower 240 can be rotated relative to the shaft 242 by an actuator, such as actuator 256.

FIGS. 26-36 illustrate processes that can be used to start-up, operate, and shutdown of the material handling machine 100.

FIG. 26 provides an overview of the overall operation process of the material handling machine 100, which includes ten steps. At block 2602 the process starts. At block 2604, step 1 of the process can be starting the generator, which can be diesel generator 110. At block 2606, step 2 of the process can be starting the air compressor, which can be compressor 108. At block 2608, step 3 of the process can be start-up of the hydraulic pump, which can be pumps 142. At block 2610, step 4 of the process can be start-up of the conveyors, including the material handling conveyors 140. At block 2612, step 5 of the process can be start-up of the tower, which can be tower 240. At block 2614 the start-up of the material handling machine 100 is complete. At block 2616, the process of operating the material handling machine 100 can start. At block 2618, step 6 of the process can be operating the material delivery system, which can include operating the hopper and material conveyor assembly 116. At block 2620, step 7 of the process can be operating the bag conveyors, which can include the production conveyors 204, the inclined conveyors 206, and the shuttle conveyors 208. At block 2622, step 8 of the process can be belt speed adjustment, which is an optional step that can be used if desired to adjust the speed at which any of the conveyor belts can be operated. At block 2624, step 9 of the process can relate to the operation of other machine functions, such as operation of the hydraulic cooling fans. At block 2626, a determination can be made as to whether the material handling machine 100 should be closed down. If the answer is no, then the operations processes of steps 6-9 can continue to be run, or can be run again. If the answer is yes, then step 10 of the process at block 2628 can be shutdown of the material handling machine 100. At block 2630, the process ends.

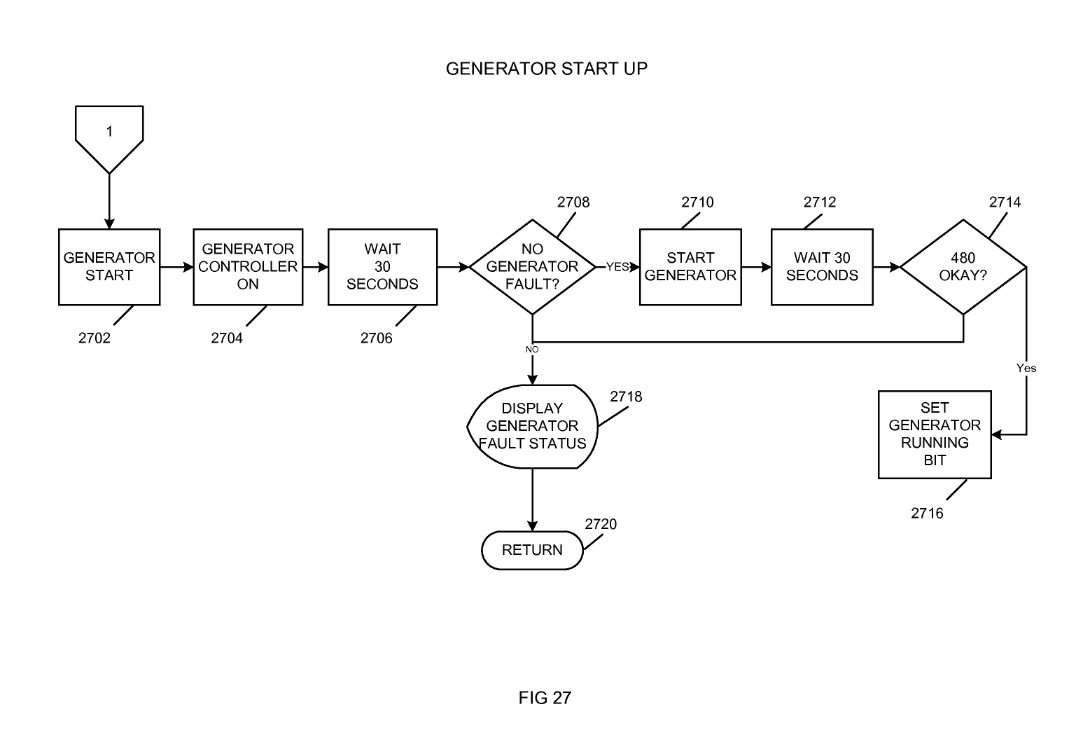

FIG. 27 illustrates a generator start-up process that the material handling machine 100 can undergo at step 1, block 2604 of FIG. 26. The process starts at block 2702, then proceeds to block 2704, where the generator controller is turned on. The process proceeds to block 2706, which is a first wait period that can be about 30 seconds. The process proceeds to block 2708, where the system determines whether the generator is operating properly or has a fault or error condition. If the determination at block 2708 is yes, then the process proceeds to block 2710, where operation of the generator is started, and then proceeds to a second wait period, which can be about 30 seconds. After the second wait period, the process proceeds to 2714, where the system determines whether the generator is operating properly. If the determination at block 2714 is yes, then the process proceeds to block 2716, where a databit indicating that the generator is running is set in data which indicates the operating state of the machine. If the determination at either block 2708 or block 2714 is no, then the process proceeds to block 2718, where a generator fault status is displayed, and then the process of FIG. 27 terminates at block 2720.

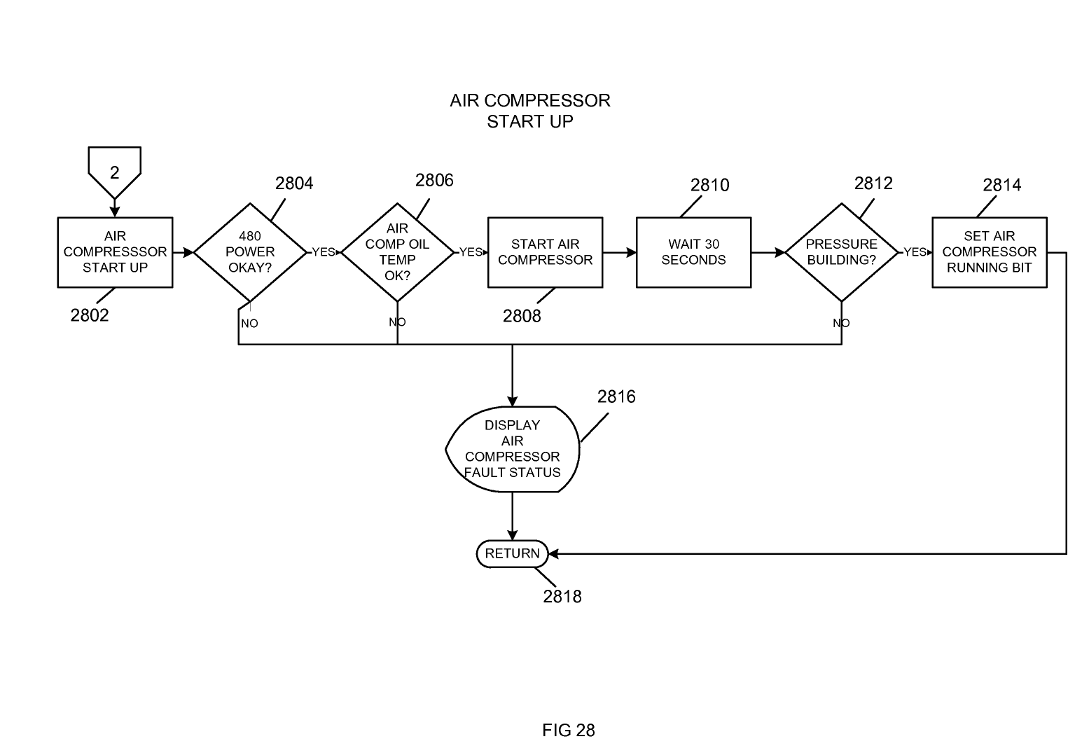

FIG. 28 illustrates an air compressor start-up process that the material handling machine 100 can undergo at step 2, block 2606 of FIG. 26. The process starts at block 2802 and then proceeds to block 2804, where the system determines whether the 480 volt power is operating properly. If the determination at block 2804 is yes, then the process proceeds to block 2806, where the system determines whether the air compressor oil temperature is ok. If the determination at block 2806 is yes, then the process proceeds to block 2808, where the air compressor is started. Then at block 2810 is a wait period that can be about 30 seconds. After the wait period, the process proceeds to block 2812, where the system determines whether pressure is building in the pneumatic system. If the determination at block 2812 is yes, then the process proceeds to block 2814, where a databit indicating the air compressor is running is set in data which indicates the operating state of the machine, and then proceeds to block 2818 where the process of FIG. 28 terminates. If the determination at any of blocks 2804, 2806, or 2812 is no, then the process proceeds to block 2816, where a compressor fault status is displayed, and then the process proceeds to block 2818 where the it returns to start at block 2606 on FIG. 26.

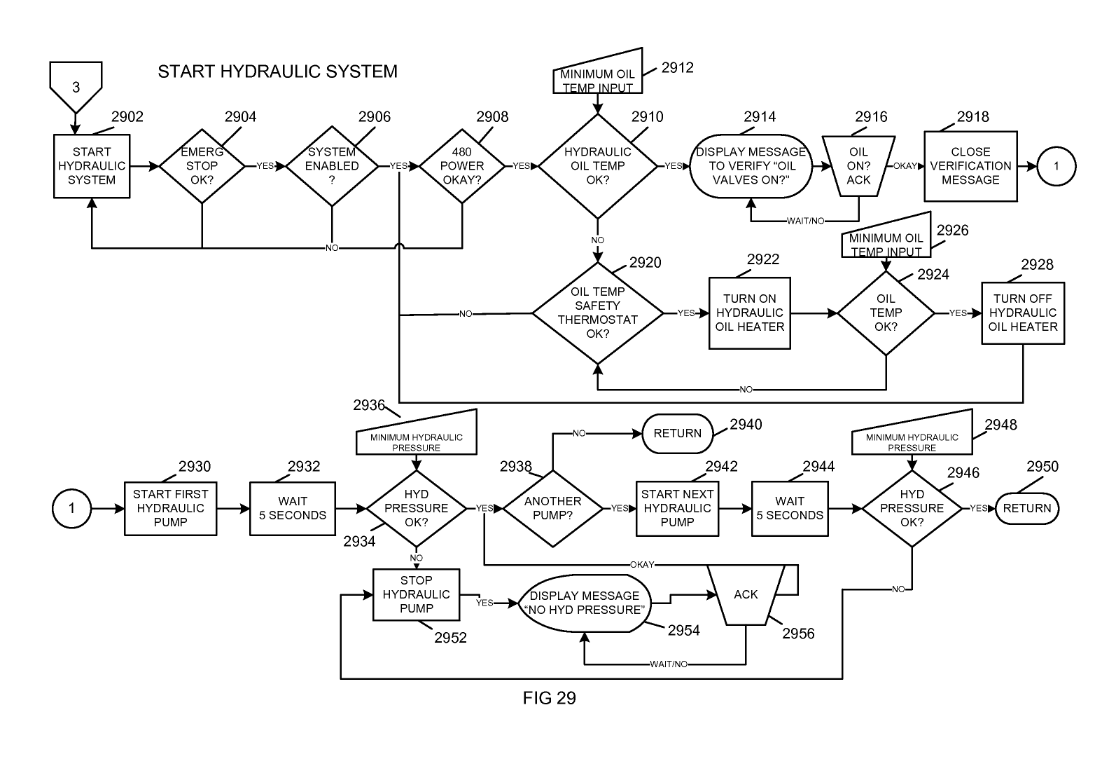

FIG. 29 illustrates a hydraulic system start-up process that the material handling machine 100 can undergo at step 3, block 2608 of FIG. 26. The process starts at block 2902 and then proceeds to block 2904, where the system determines whether the emergency stop is active or has been appropriately reset after a previous activation. If the determination at block 2904 is yes, then the process proceeds to block 2906, where the system determines whether the system is enabled by the operator to ensure that it is safe to operate the system. If the determination at block 2906 is yes, then the process proceeds to block 2908, where the system determines whether the 480 volt power is present. If the determination at any of blocks 2904, 2906, or 2908 is no, then the process returns to block 2902. If the determination at block 2908 is yes, then the process proceeds to block 2910, where the system determines whether the hydraulic oil temperature is ok. The determination is made based on input of a minimum acceptable oil temperature at block 2912. If the determination at block 2910 is yes, then the process proceeds to block 2914, where the system sends an internal message to verify whether the oil valves are on. The process then proceeds to block 2916, where the system determines whether an acknowledgement has been received that the oil valves are on. This requires that the operator verify that the oil supply valves are correctly set for the pump start up. If the determination at block 2916 is no, then the process proceeds back to block 2914. If the determination at block 2916 is yes, then the process proceeds to block 2918, where the system closes the verification message and proceeds to block 2930.

At block 2930, the first hydraulic pump is started, and then the process proceeds to a wait period at block 2932, which can be about 5 seconds. After the wait period at block 2932, the process proceeds to block 2934, where the system determines whether the hydraulic pressure is ok. The determination is made based on input of a minimum acceptable hydraulic pressure at block 2936. If the determination at block 2934 is yes, then the process proceeds to block 2938, where the system determines whether there is another pump. If the determination at block 2938 is no, then the process terminates at block 2940. If the determination at block 2938 is yes, then the process proceeds to block 2942, where the next hydraulic pump is started, and then the process proceeds to a wait period at block 2944, which can be about 5 seconds. After the wait period at block 2944, the process proceeds to block 2946, where the system determines whether the hydraulic pressure is ok. The determination is made based on input of a minimum acceptable hydraulic pressure at block 2948. If the determination at block 2946 is yes, then the process ends at block 2950. If the determination at either block 2934 or block 2946 is no, then the process proceeds to block 2952, where the system stops the relevant hydraulic pump, and then proceeds to block 2954, where the system sends a message indicating no hydraulic pressure to the operator for acknowledgement from the operator interface and corrective action. The process then proceeds to block 2956, where the system determines whether an acknowledgement has been received that there is no hydraulic pressure. If the determination at block 2956 is no, then the process proceeds back to block 2954. If the determination at block 2956 is yes, then the process proceeds to block 2938.

Referring back to block 2910, if the determination is no, the hydraulic oil temperature is not ok (does not meet the minimum required temperature, then the process proceeds to block 2920, where the system determines whether the oil temperature safety thermostat is operating below the maximum temperature (a safety back up system). If the determination at block 2920 is no, then the process proceeds back to block 2908. If the determination at block 2920 is yes, then the process proceeds to block 2922, where the hydraulic oil heater is turned on. The process then proceeds to block 2924, where the system determines whether the hydraulic oil temperature is ok. The determination is made based on input of a minimum acceptable oil temperature at block 2926. If the determination at block 2924 is yes, then the process proceeds to block 2928, where the hydraulic oil heater is turned off, and then the process proceeds back to block 2908. If the determination at block 2924 is no, then the process proceeds to block 2920.

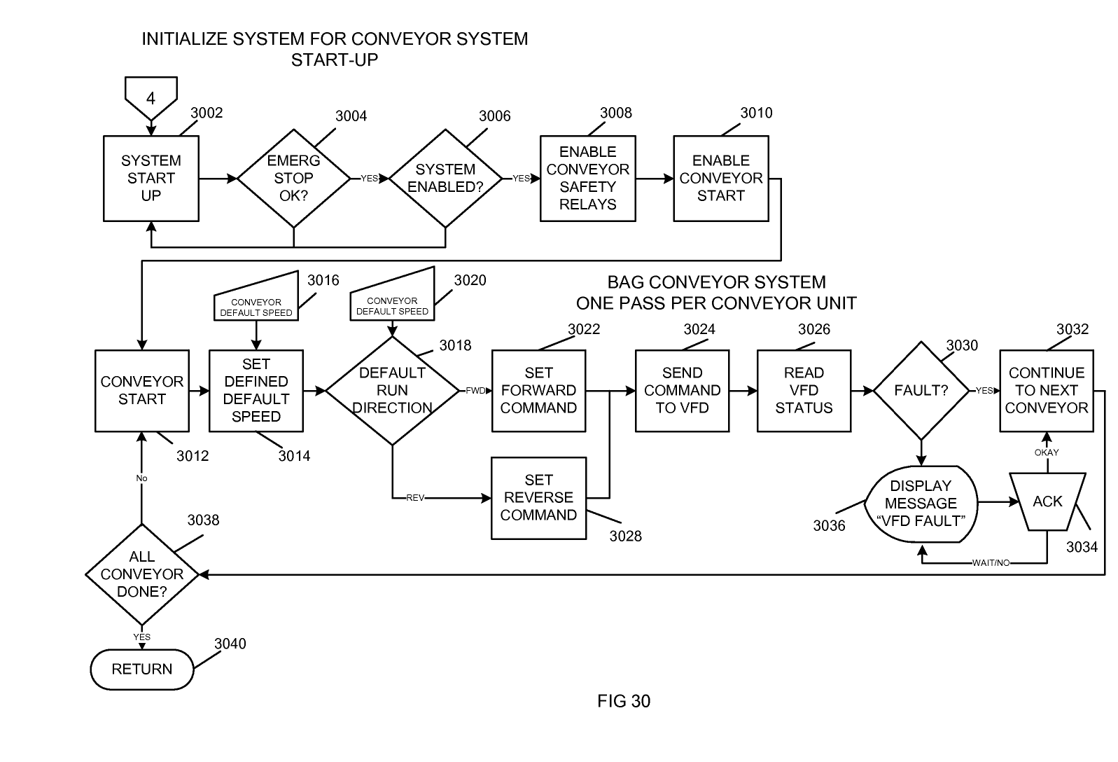

FIG. 30 illustrates an initializing process for start-up of the conveyors that the material handling machine 100 can undergo at step 4, block 2610 of FIG. 26. The process starts the conveyor system start-up at block 3002. The process then proceeds to block 3004, where the system determines whether the emergency stop is not set. If the determination at block 3004 is yes, then the process proceeds to block 3006, where the system determines whether the conveyor system is enabled to start by the operator. If the determination at either block 3004 or 3006 is no, then the process proceeds back to block 3002. If the determination at block 3006 is yes, then the process proceeds to block 3008, where the conveyor safety relays are enabled which provide a method for immediate conveyor closed down in an emergency (E-Stop). Then, at block 3010, where the system enables start of the conveyor, and at block 3012 the conveyor is started. The process then proceeds to block 3014, where the system sets the defined default speed of the conveyor. The default speed of the conveyor can be defined by input of a default speed at block 3016. The process then proceeds to block 3018, where the system sets the default run direction of the conveyor. The default run direction of the conveyor can be defined by input of a default run direction at block 3020. If the default run direction of the conveyor is forward, then the process then proceeds to block 3022, where the system sets the forward command. If the default run direction of the conveyor is reverse, then the process then proceeds to block 3028, where the system sets the reverse command. From either block 3022 or block 3028, the process proceeds to block 3024, where the set command is sent to VFD (Variable Frequency Drive), and then to block 3026, where the VFD status is read. Upon reading of the VFD status at block 3026, the process proceeds to block 3030, where the system determines whether there is a fault. If the determination at block 3030 is no, then the process proceeds to block 3032, where the system determines to continue to the next conveyor, and to block 3038, where the system determines whether all of the conveyors have been started. If the determination at block 3038 is no, then the process returns to block 3012 to start the next conveyor. If the determination at block 3038 is yes, then the process terminates at block 3040. If it is determined at block 3030 that the fault has occurred, a “VFD Fault” message is sent at block 3036. Once the message is acknowledged at block 3034, by the operator, processing proceeds to block 3032.

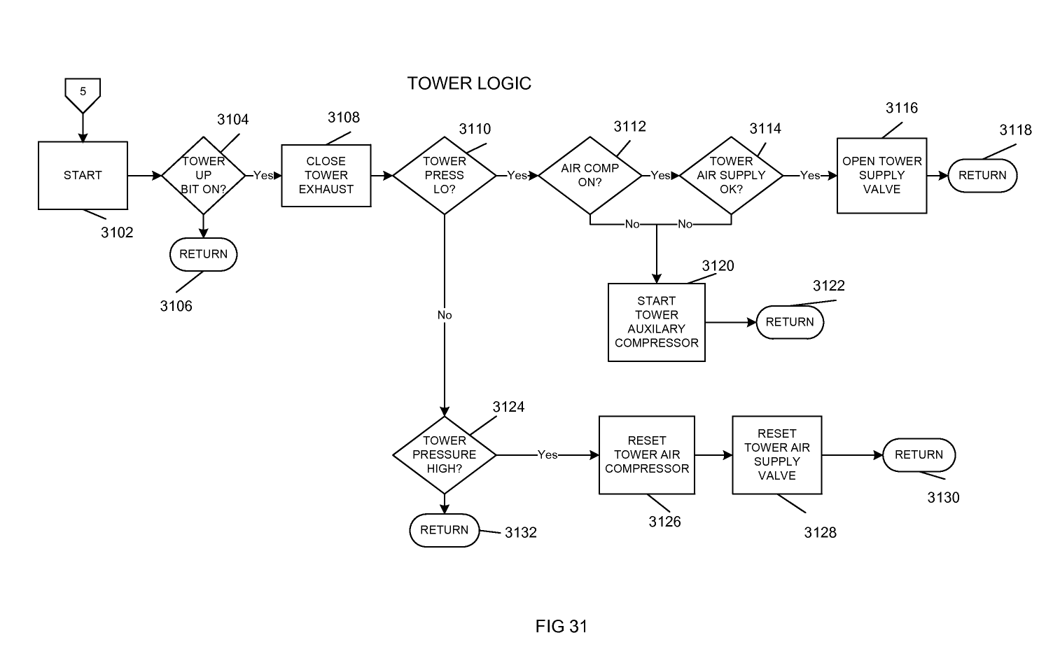

FIG. 31 illustrates a tower logic start-up process that the material handling machine 100 can undergo at step 5, block 2612 of FIG. 26. The process starts at block 3102 and proceeds to block 3104, where the system determines whether the tower up bit is set in the machine state data. If the determination at block 3104 is no, then the process terminates at block 3106. If the determination at block 3104 is yes, then the process proceeds to block 3108, where the system closes the tower exhaust, and then to block 3110, where the system determines whether the tower pressure is low. If the determination at block 3104 is yes, then the process proceeds to block 3112, where the system determines whether the air compressor is on. If the determination at block 3112 is yes, then the process proceeds to block 3114, where the system determines whether the tower air supply is operating properly from the digital pressure gauge. If the determination at either block 3112 or block 3114 is no, then the process proceeds to block 3120, where the system starts an tower auxiliary compressor, and then the process terminates at block 3122. If the determination at block 3114 is yes, then the process proceeds to block 3116, where the system opens the tower supply valve and process terminates at block 3118. If the determination at block 3110 is no, then the process proceeds to block 3124, where the system determines whether the tower pressure is high. If the determination at block 3124 is yes, then the process proceeds to block 3126, where the system resets the tower air compressor, and then to block 3128, where the system resets the tower air supply valve, and then the process terminates at block 3130. If the determination at block 3124 is no, then the process terminates at block 3132.

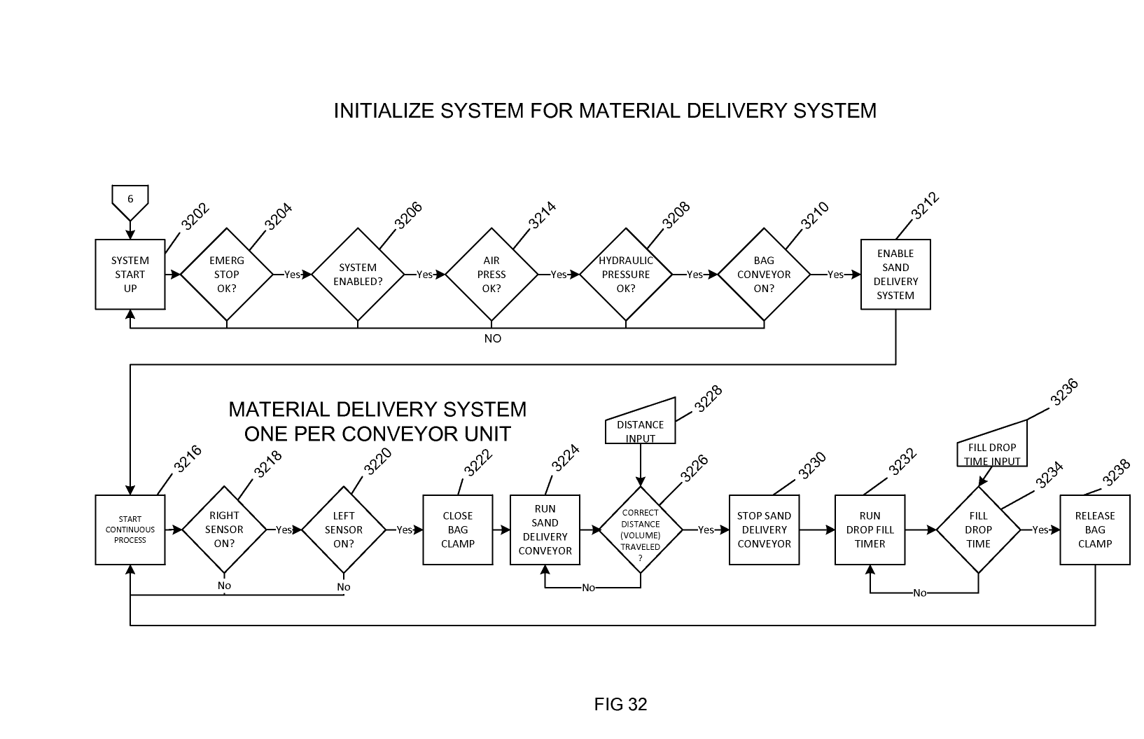

FIG. 32 illustrates an initialization and operation process for the material delivery system that the material handling machine 100 can undergo at step 6, block 2618 of FIG. 26. The process starts at block 3202 and then proceeds to block 3204, where the system determines whether the emergency stop is properly set to allow the machine to run. If the determination at block 3204 is yes, then the process proceeds to block 3206, where the system determines whether the system is enabled by the operator to operate. If the determination at block 3206 is yes, then the process proceeds to block 3214, where the system determines whether the air pressure is ok. If the determination at block 3214 is yes, then the process proceeds to block 3208, where the system determines whether the hydraulic pressure is ok. If the determination at block 3208 is yes, then the process proceeds to block 3210, where the system determines whether the bag conveyor is on. If the determination at any of blocks 3204, 3206, 3214, or 3208 is no, then the process proceeds back to block 3202. If the determination at block 3210 is yes, then the process proceeds to block 3212, where the system enables the sand delivery system. The process then proceeds to block 3216, where the system starts the continuous material delivery process. The process then proceeds to block 3218, where the system determines whether the right sensor (proximity detector 182) is on, and if the determination is yes the process proceeds to block 3220, where the system determines whether the left sensor (proximity detector 182) is on. If the determination at either block 3218 or block 3220 is no, then the process proceeds back to block 3216. If the determination at block 3220 is yes, then the process proceeds to block 3222, where the system closes the bag clamp 184. The process then proceeds to block 3224, where the system runs the sand delivery conveyor (material conveyor 140), and then to block 3226, where the system determines whether the sand delivery conveyor (material conveyor 140) has traveled the correct predetermined distance. The correct predetermined distance can be input at block 3228, based on the volume of material desired to be dispensed into a bag. If the determination at block 3226 is no, then the process proceeds back to 3224, and continues to run the sand delivery conveyor (material conveyor 140). If the determination at block 3226 is yes, then the process proceeds to block 3230, where the system stops the sand delivery conveyor (material conveyor 140). The process then proceeds to block 3232, where the system runs a drop fill timer, and then to block 3234, where the system determines whether the fill drop time has elapsed. The fill drop time can be input at block 3236, and can be an amount of time that provides time for the last material to drop from the conveyor into a bag. If the determination at block 3234 is no, then the process proceeds back to block 3232. If the determination at block 3234 is yes, then the process proceeds to block 3238, where the bag clamp is released. The process then proceeds back to block 3216 in order to repeat for the next bag.

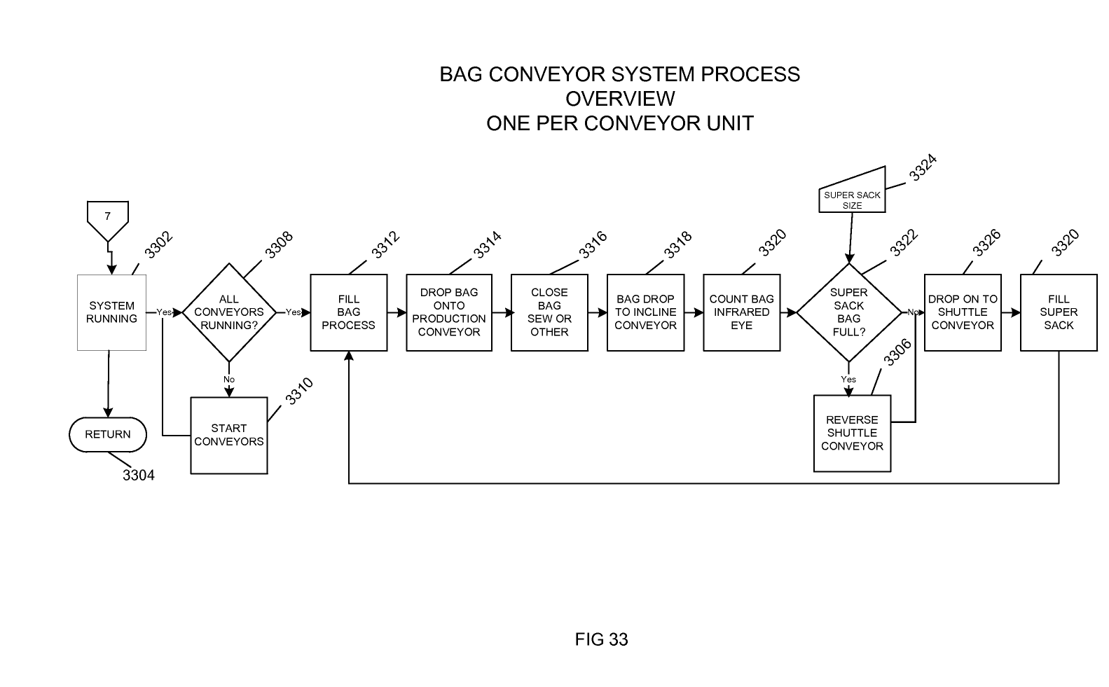

FIG. 33, with reference also to FIG. 18, illustrates bag conveyor system process that the material handling machine 100 can undergo at step 7, block 2620 of FIG. 26. The process starts at block 3302, where a determination is made as to whether the system is running. If the determination at block 3302 is no, then the process terminates at block 3304. If the determination at block 3302 is yes, then the process proceeds to block 3308, where a determination is made regarding whether all of the conveyors are running. If the determination at block 3308 is no, then the process proceeds to block 3310 where conveyors are started, and then proceeds back to block 3308. If the determination at block 3308 is yes, then the process proceeds to block 3312 for the filled bag process. At block 3314, a filled bag is dropped onto a production conveyor 204. Once the bag on the production conveyor 204 reaches the sewing station 218, the process proceeds to block 3316 where the bag is closed by sewing the bag or using some other closing means. The process then proceeds to block 3318, where the bag is dropped onto a inclined conveyor 206. The number of bags can be counted at block 3320 by an infrared eye, and the process can proceed to block 3322, where a determination can be made as to whether a super sack (storage sack 222) is full. The determination can be made based on an input at block 3324 as to the size of the super sack. If the determination at block 3322 is no, then the process can proceed to block 3326, where the bag can be dropped onto a shuttle conveyor 208, and the process can continue to block 3328 to drop the bag in the super sack. The process then proceeds back to block 3312 for the next bag. If the determination at block 3322 is yes, then the process can proceed to block 3306, where the direction of the shuttle conveyor 208 can be reversed in order to start filling a super sack at the opposite end of the shuttle conveyor 208, and then the process can proceed to block 3326.

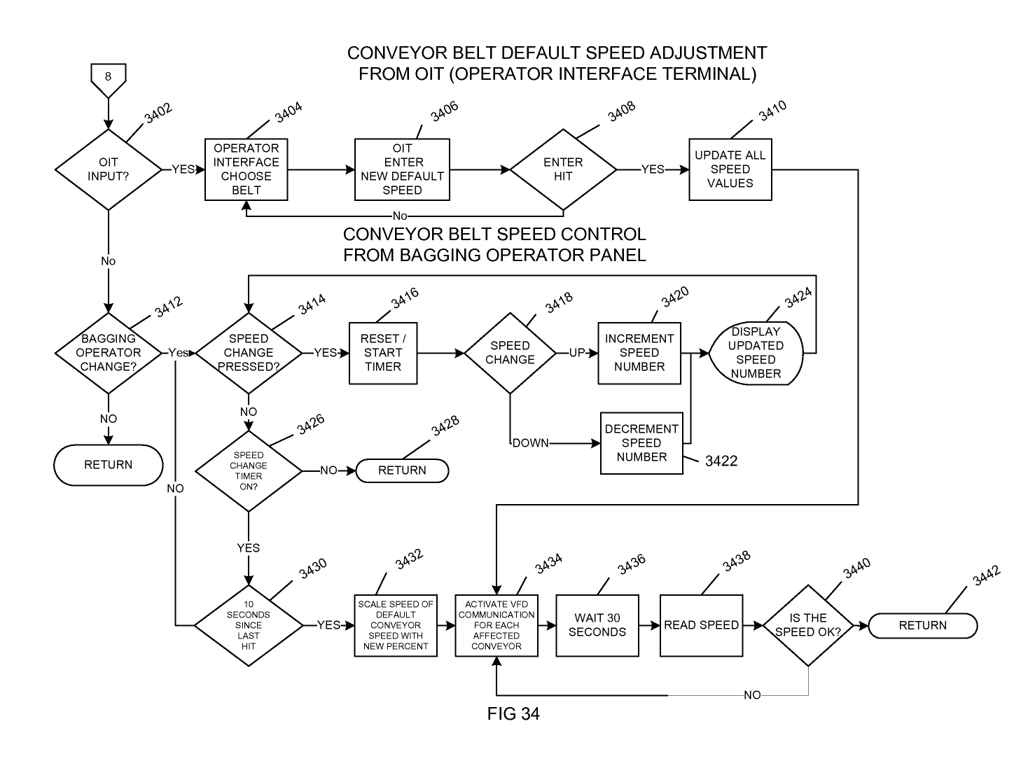

FIG. 34 illustrates a conveyor belt speed adjustment processes and a conveyor belt speed control process that the material handling machine 100 can undergo at step 8, block 2622 of FIG. 266.

The process for speed adjustment can start at block 3402 when the system is running, and can proceed to block 3404, where the operator can select the belt for which the speed will be changed using the Operator Interface Terminal (OIT). The process can then proceed to block 3406, where the operator can enter a new default speed. The process can then proceed to block 3408, where the operator can hit enter to enter the new speed into the system. The process can then proceed to block 3410, where the system updates all speed values. The process can then proceed to block 3434, where the system activates variable frequency drive (VFD) communication for each affected conveyor. The process can then proceed to block 3436, which is a wait period that can be about 30 seconds. After the wait period, the process can proceed to block 3438, where the system can read the updated speed and direction, and then to block 3440 where the system determines if the new information is correct. If the determination at block 3440 is yes, then the process can terminate at block 3442.

The process for speed control from the Bagging Operator Station can start at block 3412. If the bagging operator enters a change, the process can proceed to block 3414, where the system can determine whether a speed change button has been pressed. If the determination at block 3414 is yes, then the process can proceed to block 3416, where the speed change timer can be reset or started, and then to block 3418 to start implementation of the speed change. The reset/start timer provides a wait time to determine is a speed change button will be pressed again in rapid succession. From block 3418, the process can proceed to block 3420 to increment the speed number (increase the speed), or to block 3422 to decrement the speed number (decrease the speed), depending on whether the speed increase or the speed decrease button has been pressed. From block 3420 or block 3422, the process can proceed to block 3424, where the system can display the updated speed number, and then the process can return to block 3414. If the determination at block 3414 is no then the process can proceed to block 3426, where the system determines whether the speed change timer is on. If the determination at block 3426 is no, then the process can terminate at block 3428. If the determination at block 3426 is yes, then the process can proceed to block 3430, where the system determines whether a number of seconds, such as 10, has passed since the speed change was pressed. If the determination at block 3430 is no, then the process can proceed to block 3414. If the determination at block 3430 is yes, then the process can proceed to block 3432, where the system can scale the speed of the default conveyor speed with the new from the settings on the panel. The process can then proceed to block 3434, where the system activates VFD communication for each affected conveyor. The process can then proceed to block 3436, which is a wait period that can be about 30 seconds. After the wait period, the process can proceed to block 3438, where the system can verify that the speed was updated correctly, and then to block 3440 where the system determines if the new settings in the speed control is correct. If the determination at block 3440 is yes, then the process can terminate at block 3442.

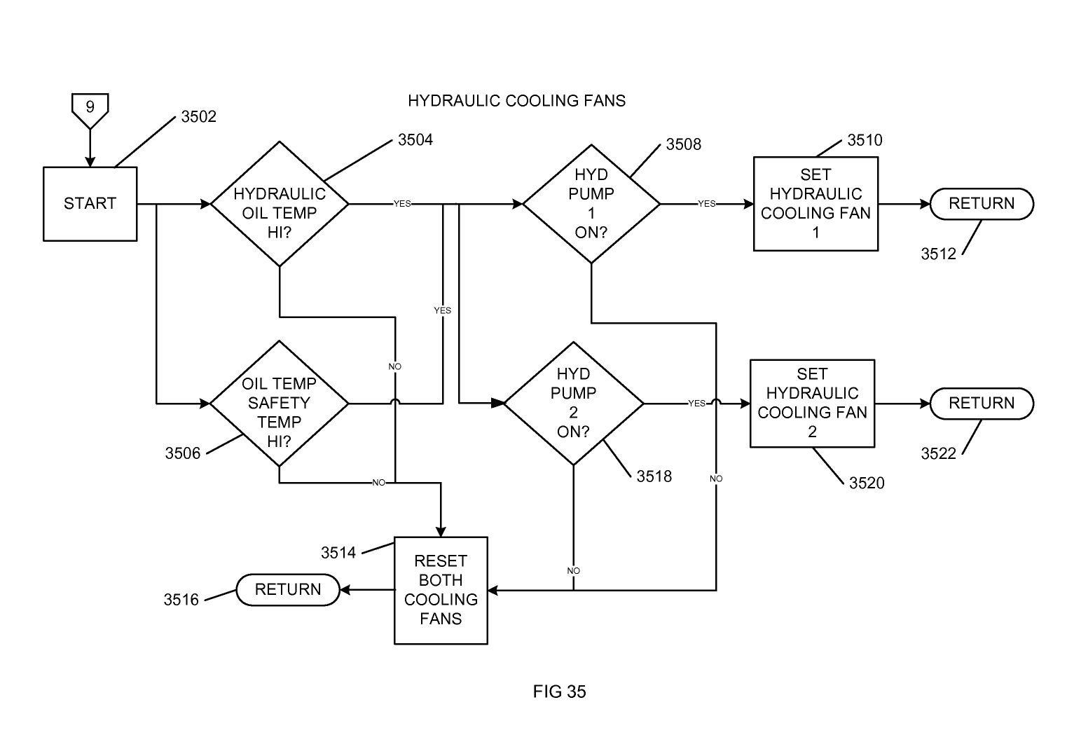

FIG. 35 illustrates an hydraulic cooling fan operation process that the material handling machine 100 can undergo at step 9, block 2624 of FIG. 26. The hydraulic cooling fan operation starts at block 3502. The process proceeds to block 3504 and block 3506, where the system determines whether the hydraulic oil temperature is high, by two different safety methods, based on whether the oil temperature safety temperature has been exceeded. The two paths provide a redundant safety system for the temperature of the hydraulic oil. If the system determines that the answer at block 3502 or 3504 is no, then the process proceeds to block 3514, where cooling fans are turned off, and then at block 3516 the process terminates. If the system determines that the answer at either block 3502 or 3504 is yes, then the process proceeds to block 3508, where the system determines whether hydraulic pump 1 is on, and to block 3518, where the system determines whether hydraulic pump 2 is on. If the system determines that the answer at block 3508 or 3518 is no, then the process proceeds to block 3514. If the system determines that the answer at block 3508 is yes, then the process proceeds to block 3510, where hydraulic cooling fan 1 is turned on. Then, the process terminates at block 3512. If the system determines that the answer at block 3518 is yes, then the process proceeds to block 3520, where hydraulic cooling fan 2 is turned on, then the process terminates at block 3522.

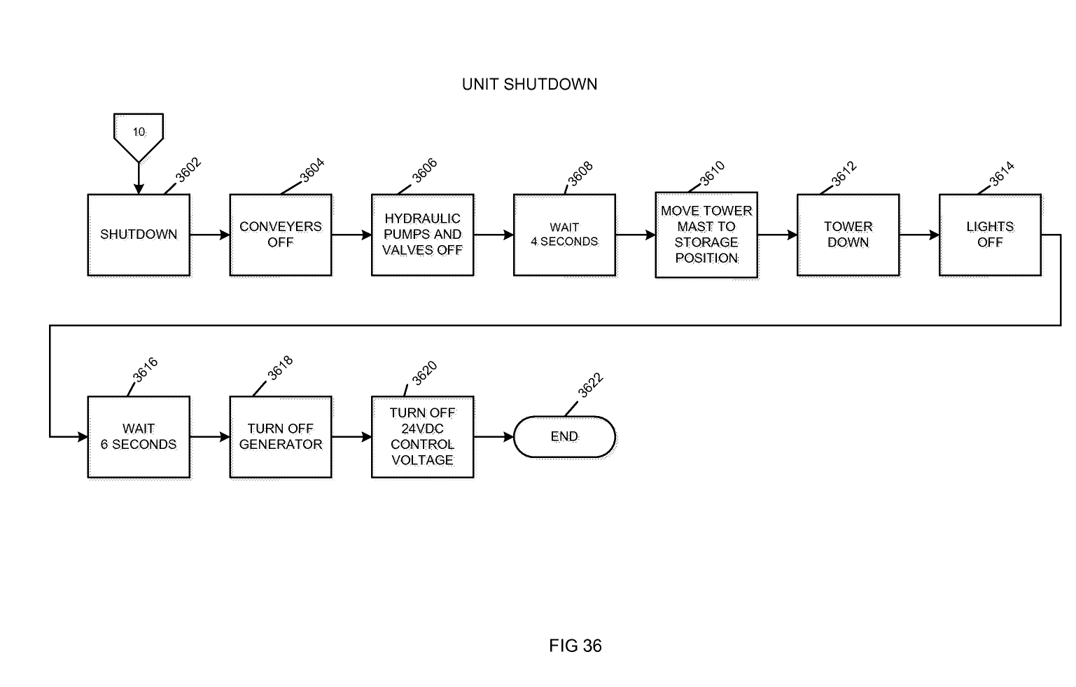

FIG. 36 illustrates a shutdown process that the material handling machine 100 can undergo at step 10, block 2628 of FIG. 26. Shutdown starts at shutdown block 3602, then the conveyors are turned off at block 3604. The hydraulic pumps and valves are closed off at block 3606, then there can be a wait period at block 3608 in order to provide time for the closed off of the hydraulics to be complete. The wait period can be a few seconds in duration, such as about 4 seconds. At block 3610, the tower lights can be placed in a storage position. At block 3612, the tower 240 can be lowered down from an operation position to a stowed position. At block 3614, the lights of the tower can be turned off, then there can be a wait period at block 3616 in order to provide time for the generator to unload and reduce power to idle. The wait period can be a few seconds in duration, such as about 6 seconds. At block 3618, the generator is turned off. At block 3620, the electric power to the control system can be turned off. Finally, the shutdown process ends at block 3622.

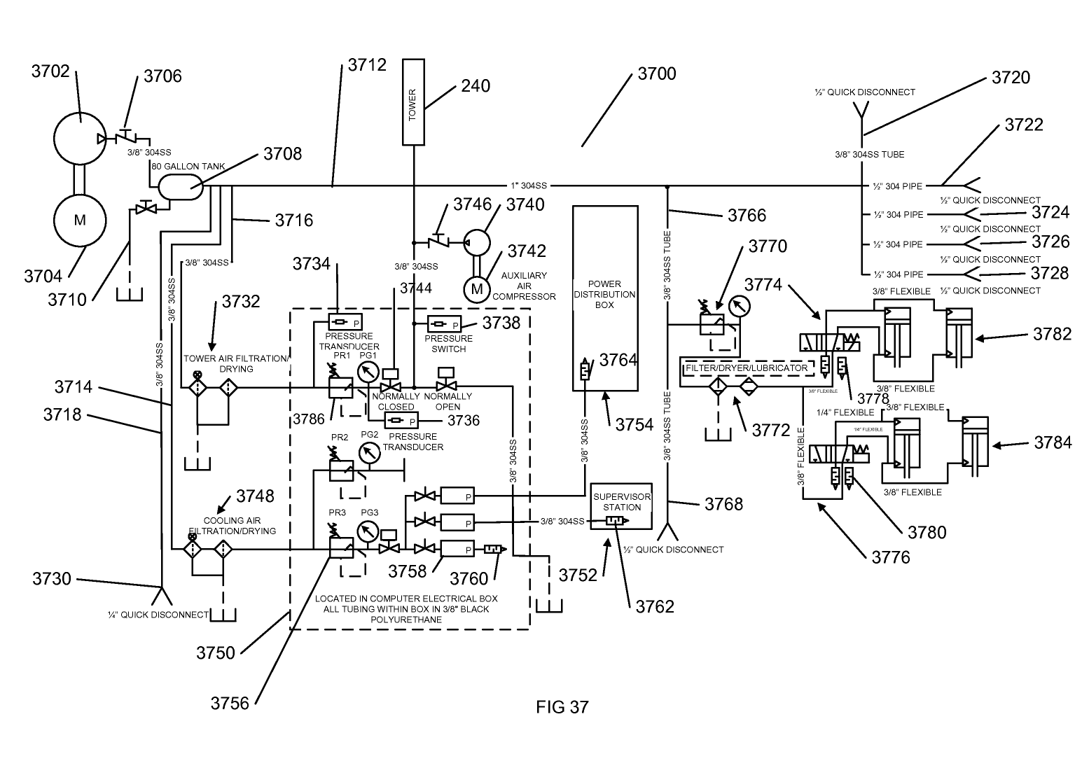

FIG. 37 is a block diagram of the pneumatic system 3700 of the material handling machine of FIG. 1. The main air compressor 3702 has a motor 3704. There is a check valve 3706 between the main air compressor 3702 and the tank 3708. The tank 3708 has a water drain line 3710. Several lines 3712-3718 extend from the tank to various systems of the material handling machine 100. Lines 3712 and 3718, for example, can provide compressed air to a number of quick disconnects 3720-3730, to allow pneumatic tools to be connected to the material handling machine 100 for use during operation. Line 3716 connects to the tower air filtration and drying system 3732 that provides air used to raise and lower the tower 240. The tower air filtration and drying system 3732 connects to a first pressure transducer 3734 that acts as a pressure sensor for the main air line, a pressure regulator and gauge 3786 and a second pressure transducer 3736 that acts as a pressure sensor for the tower 240. There is also a pressure switch 3738 that can be used to open the valve 3744 when the tower 240 requires air for lifting the tower 240. The pneumatic system 3700 also includes an auxiliary air compressor 3740, which includes a motor 3742, connected to the tower 240 through a check valve 3746, for operation of the tower without generator or AC power present. Line 3714 connects to the electrical box air filtration and drying system 3748 that provides air to cool electrical systems including the computer electrical box 3750, the supervisor station 3752, and the power distribution box 3754. As illustrated, air from the electrical box air filtration and drying system 3748 can pass through a pressure regulator and gauge 3756 into flowmeters 3758, and can be passed from the flowmeters 3758 to any of vent 3760 in the computer electrical box 3750, vent 3762 in the supervisor station, or vent 3764 in the power distribution box 3754. Line 3766 can provide air to another quick disconnect 3768, as well as to an air regulator and pressure gauge 3770 that connects to the bag clamp filtration and drying system 3772. The bag clamp filtration and drying system 3772 provides air to the bag clamp system for each bag clamp 184 associated with each material conveyor. For example, the bag clamp filtration and drying system 3772 can provide air through a first bag clamp system 3774 having solenoid clamp 3778 to a first pneumatic cylinder 3782 for a first bag clamp 184. Additionally, the bag clamp filtration and drying system 3772 can provide air through a second bag clamp system 3776 having solenoid clamp 3780 to a second pneumatic cylinder 3784 for a second bag clamp 184.

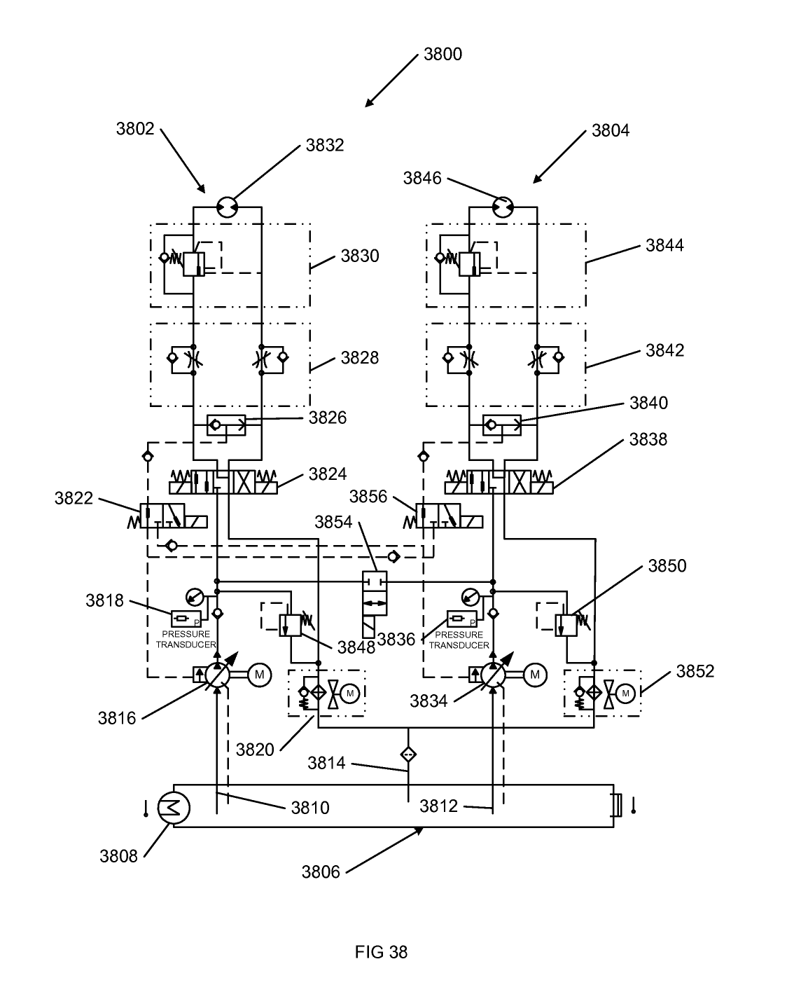

FIG. 38 is a block diagram of the hydraulic system 3800 of the material handling machine 100 of FIG. 1. The hydraulic system 3800 includes two distinct interconnected systems 3802 and 3804, which are parallel systems that connect the main tank 3806 to the hydraulic motor of each material conveyor 140 of the material handling machine 100. The main tank 3806 has a hydraulic oil heater 3808. A first intake 3810 connects from the main tank 3806 to a first hydraulic pump 3816, which is a load sense pump. Above first pump 3816, there is a first pressure and sensor gauge 3818, which connects to a first two way hydraulic solenoid valve 3824, a first shuttle valve 3826, and then a first bidirectional flow control 3828. The first bidirectional flow control 3828 connects to a first counter-balance valve 3830, which prevents backwards flow, and then to the first hydraulic motor 3832 for a material conveyor 140. Similarly, a second intake 3812 connects from the main tank 3806 to a second hydraulic pump 3834, which is a load sense pump. Above second pump 3834, there is a second pressure and sensor gauge 3836, which connects to a second two way hydraulic solenoid valve 3838, a second shuttle valve 3840, and then a second bidirectional flow control 3842. The second bidirectional flow control 3842 connects to a second counter balance valve 3844, which prevents backwards flow, and then to the second hydraulic motor 3846 for a material conveyor 140. Both systems 3802 and 3804 flow back into the radiator and tank after operation of the hydraulic motor. The hydraulic system 3800 also includes a first pressure relief valve 3848 connected to the first system 3802, that can pass oil through a first radiator 3820 into oil return 3814 and back into the main tank 3806. Similarly, a second pressure relief valve 3850 connected to the second system 3804, that can pass oil through a second radiator 3852 into oil return 3814 and back into the main tank 3806. Additionally, hydraulic cross over valves 3822, 3854 and 3856 can be used to interconnect either system 3802 or 3804 to the other, or operate both material conveyors 140 at a reduced speed in the event of a failure of either system 3802 or 3804.

As those of ordinary skill in the art would understand from the above, crossover valves 3822, 3854, and 3856 enable first pump 3816 to drive system 3802, system 3804, or both systems 3802 and 3804. Correspondingly, crossover valves 3822, 3854 and 3856 enable second pump 3834 to drive system 3804, system 3802 or both systems 3804 and 3802. The ability to drive either system 3802 or 3804 from either pump 3816 or 3834 is optional. If this functionality is not desired, those of ordinary skill will understand that crossover valves 3822, 3854 and 3856 may be eliminated.

Also, those of ordinary skill in the art will understand from the above that solenoid valves 3824 and 3838 enable hydraulic motors 3832 and 3846, respectively, to be driven in either direction. The ability to reverse motors 3832 and 3846 is optional. If this functionality is not desired, those skilled in the art will understand that solenoid valves 3824 and 3838 may be replaced with more simple solenoid valves that selectively supply or block the supply of hydraulic fluid to motors 3832 and 3804, respectively.

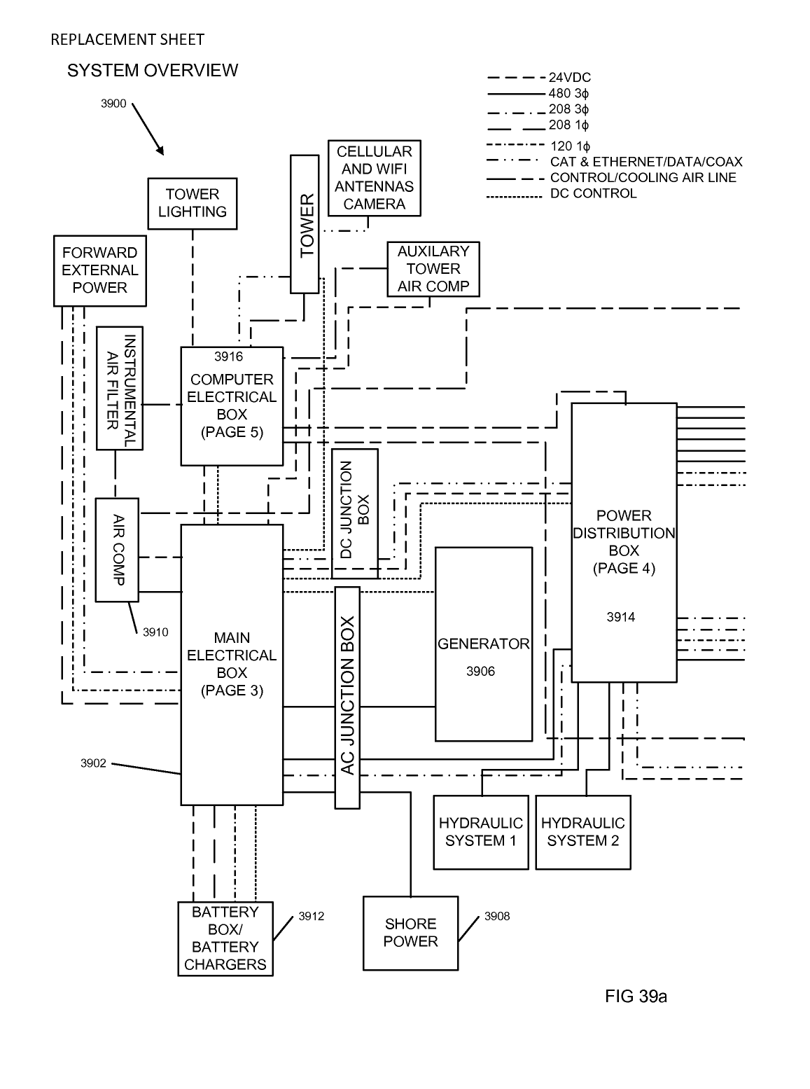

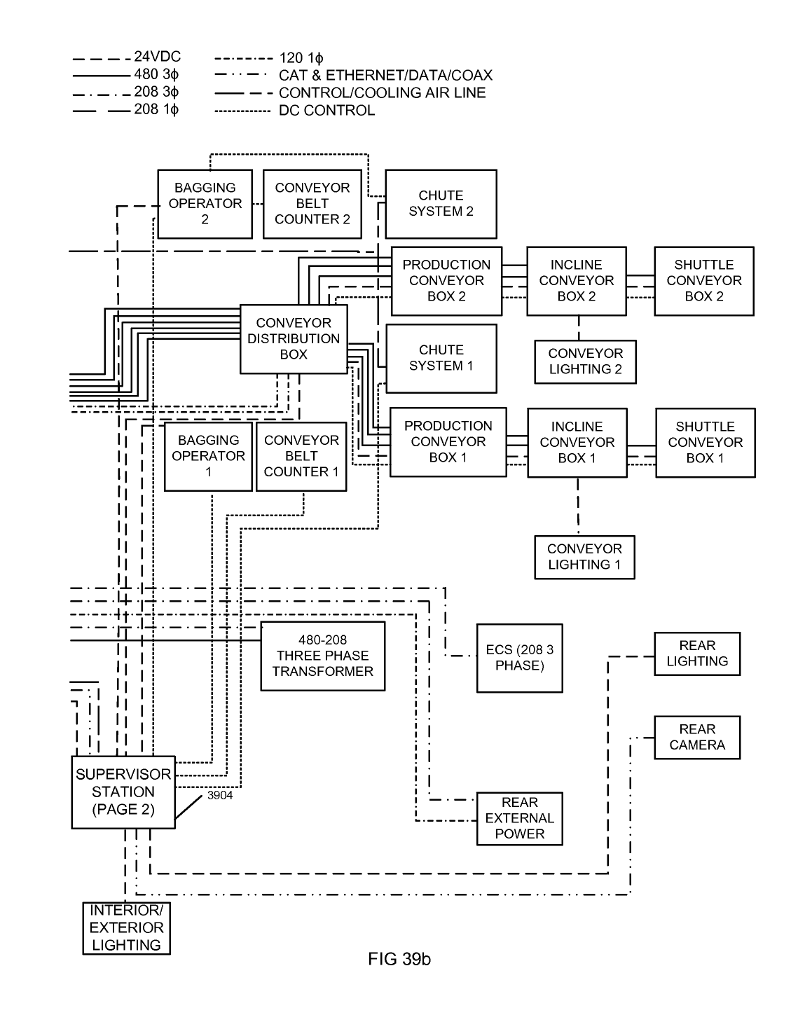

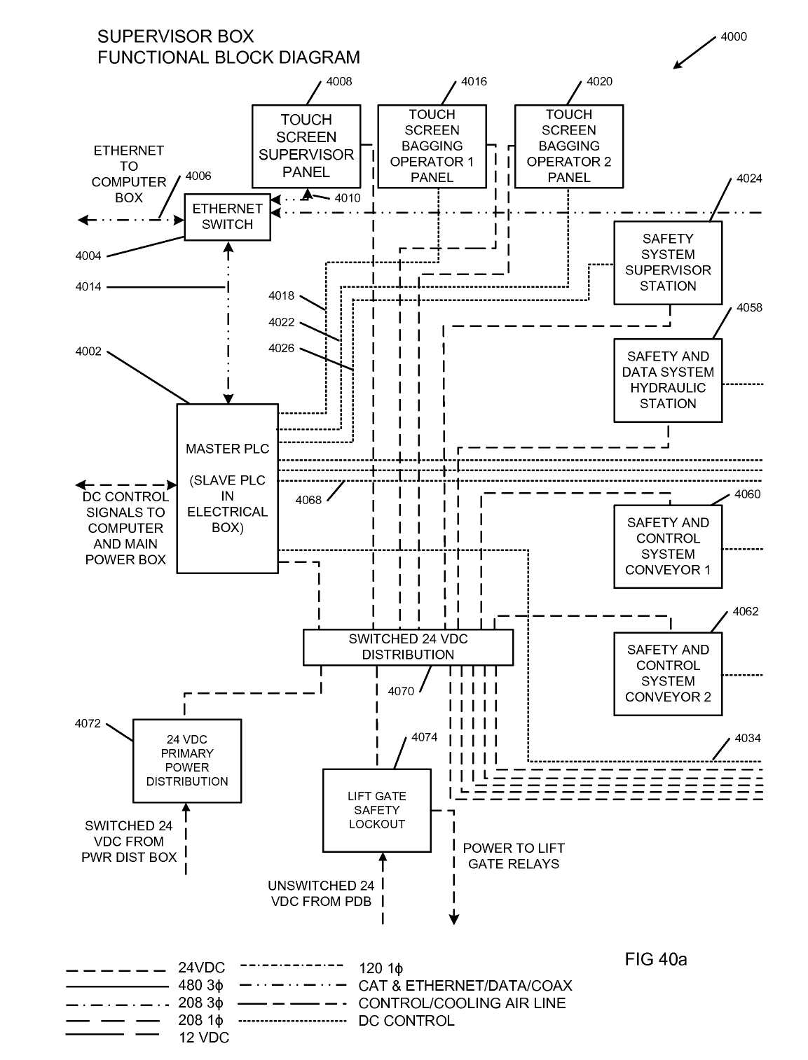

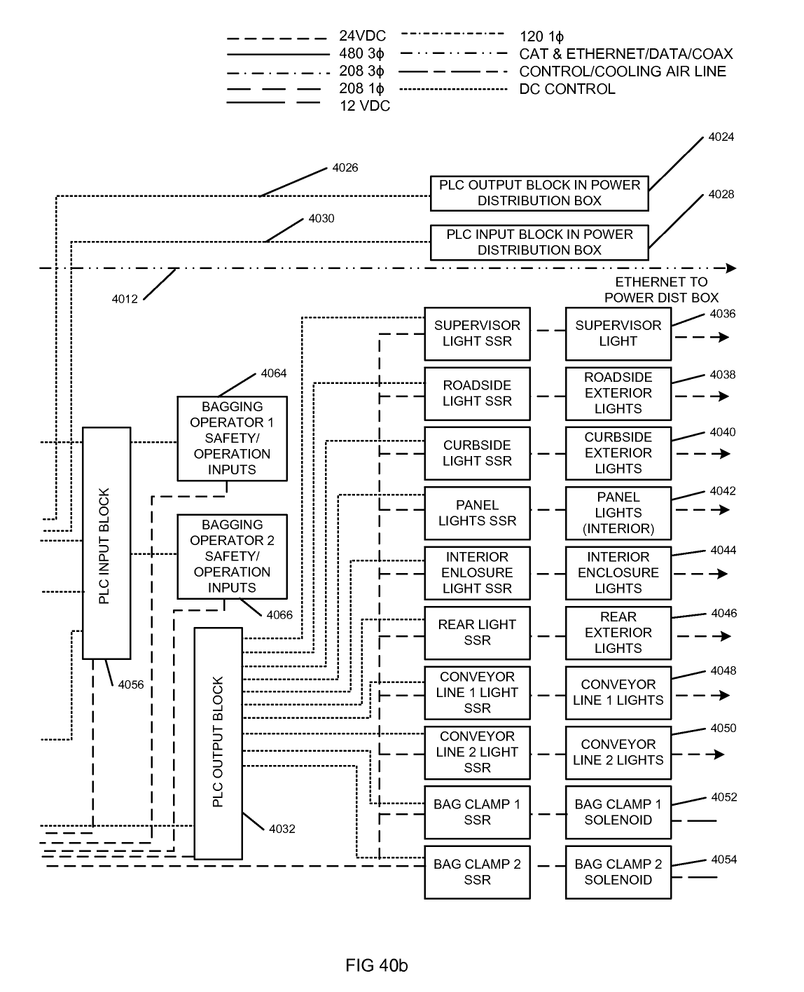

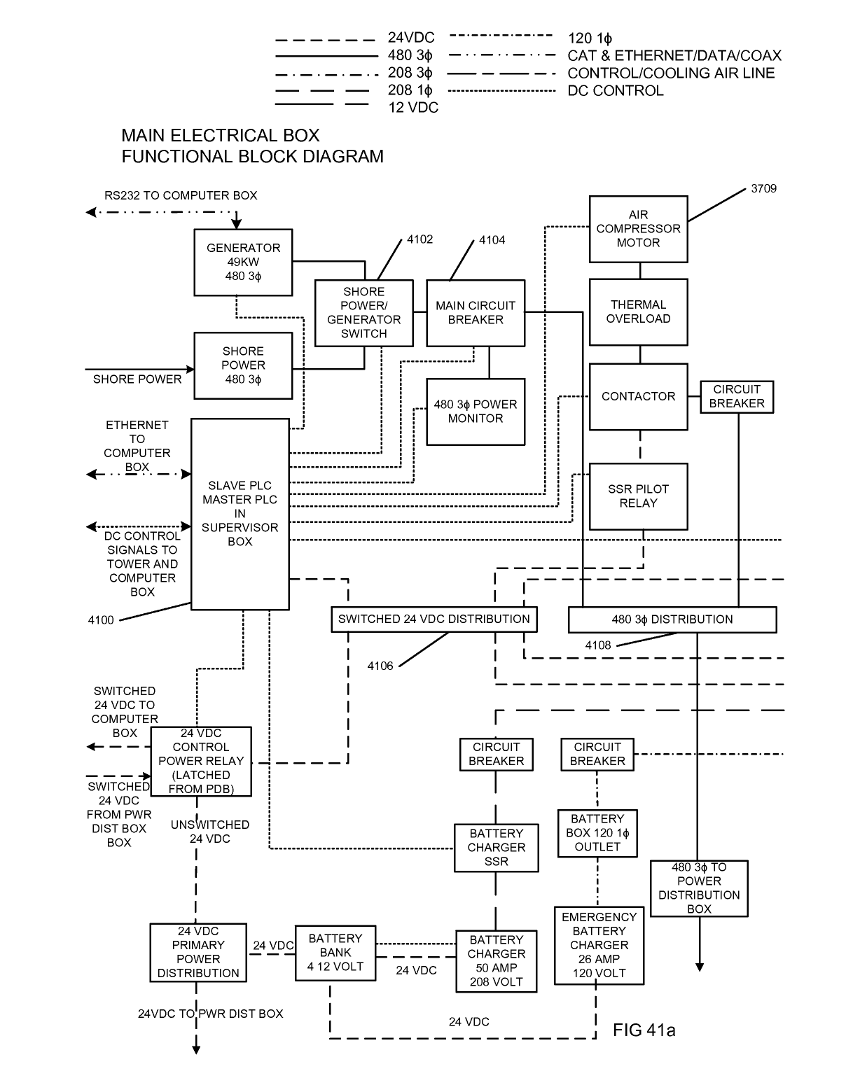

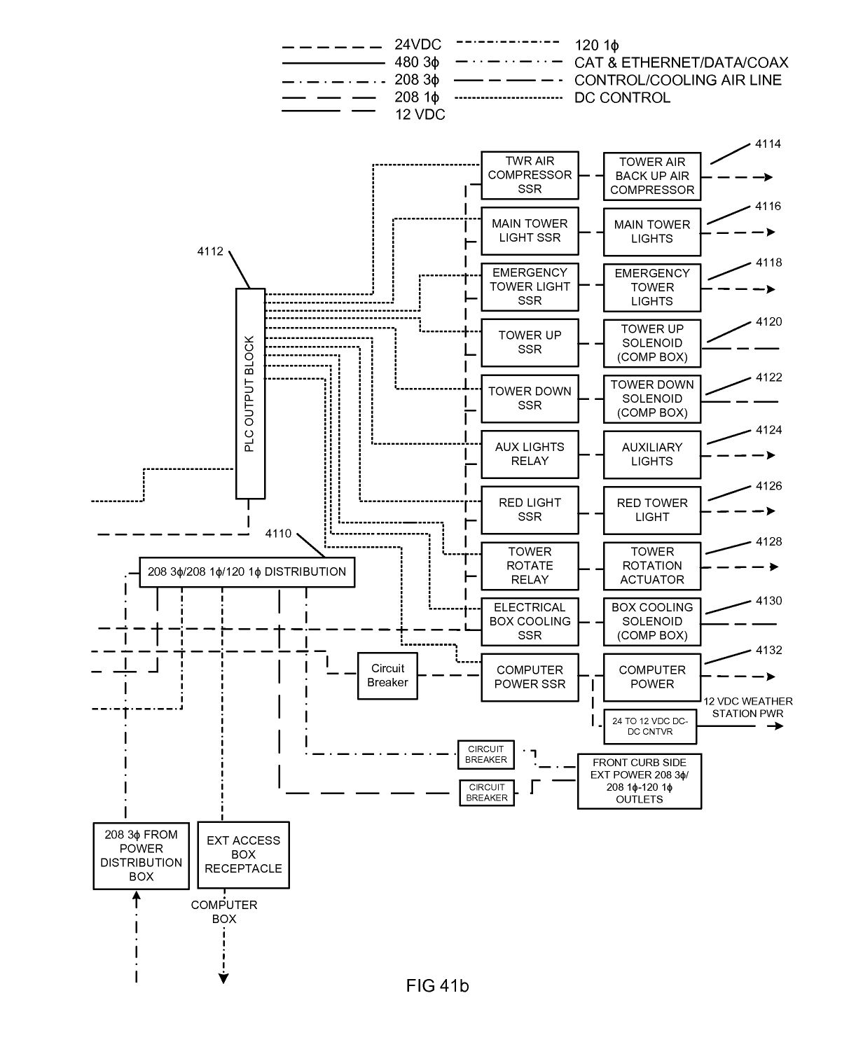

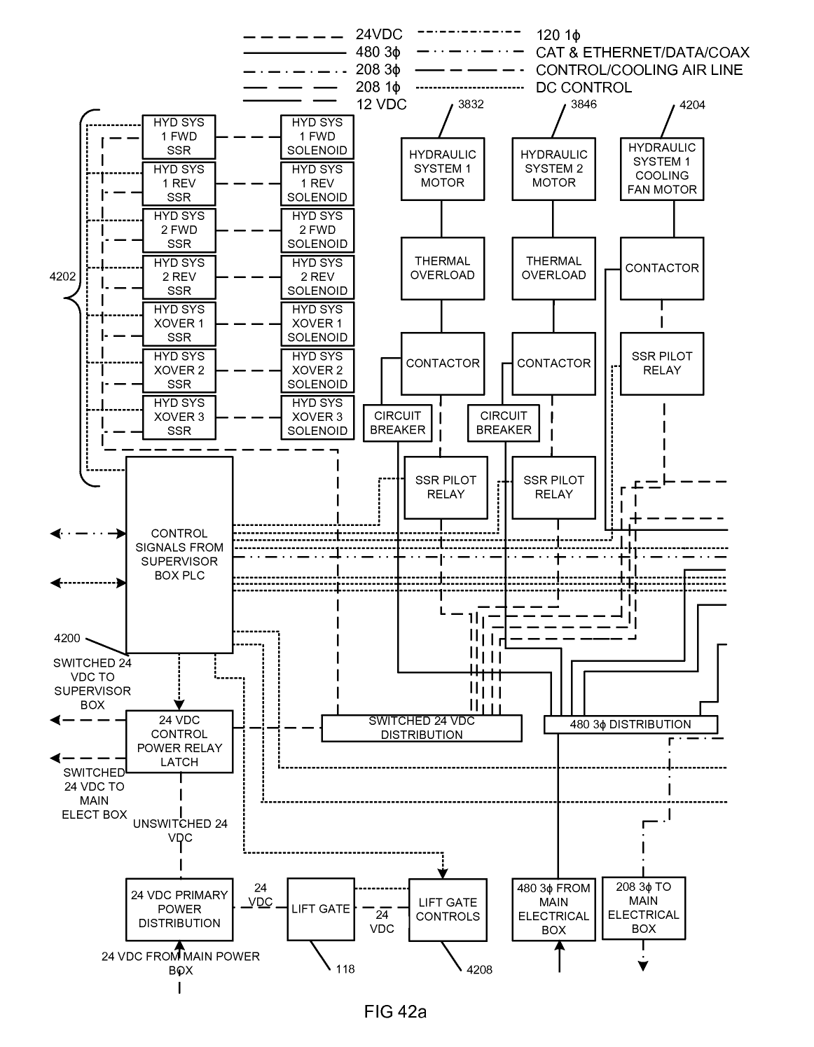

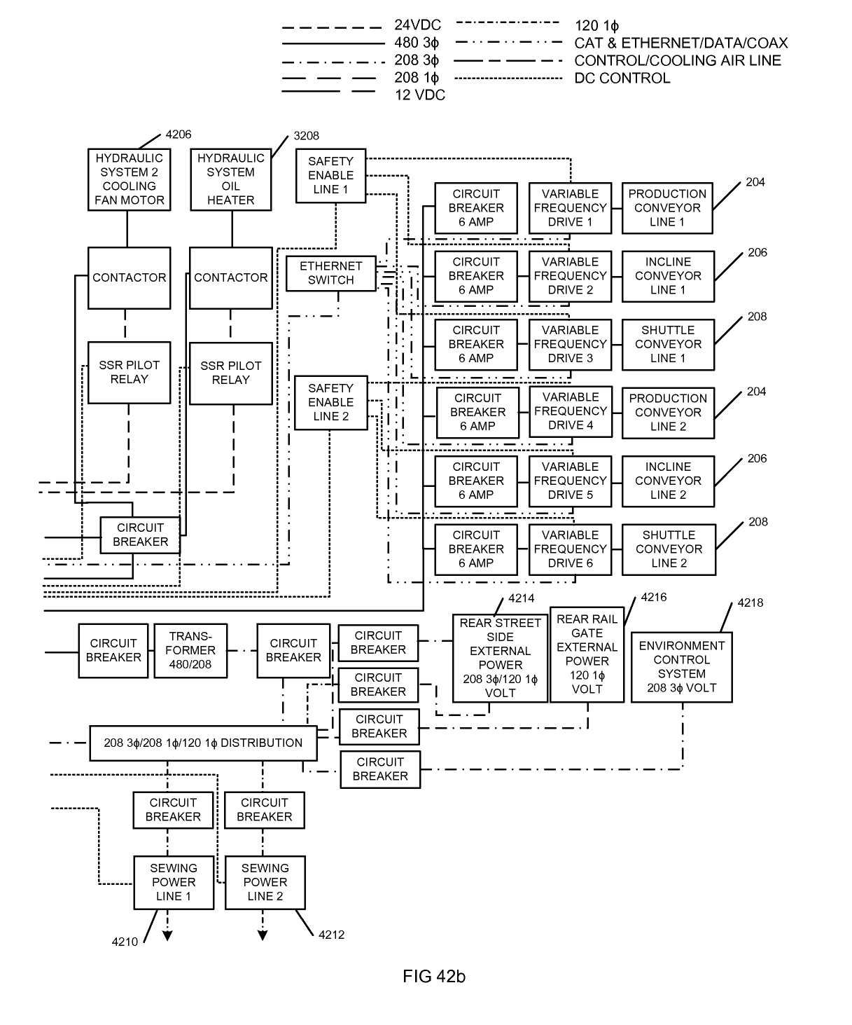

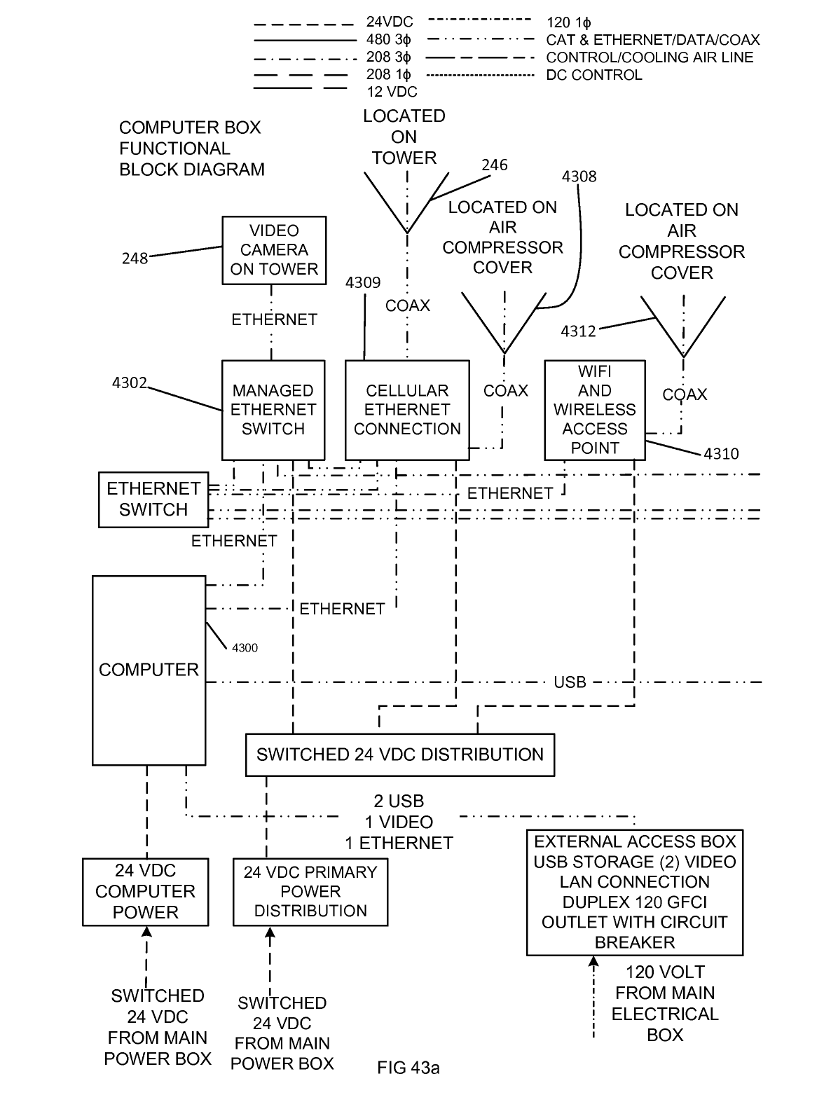

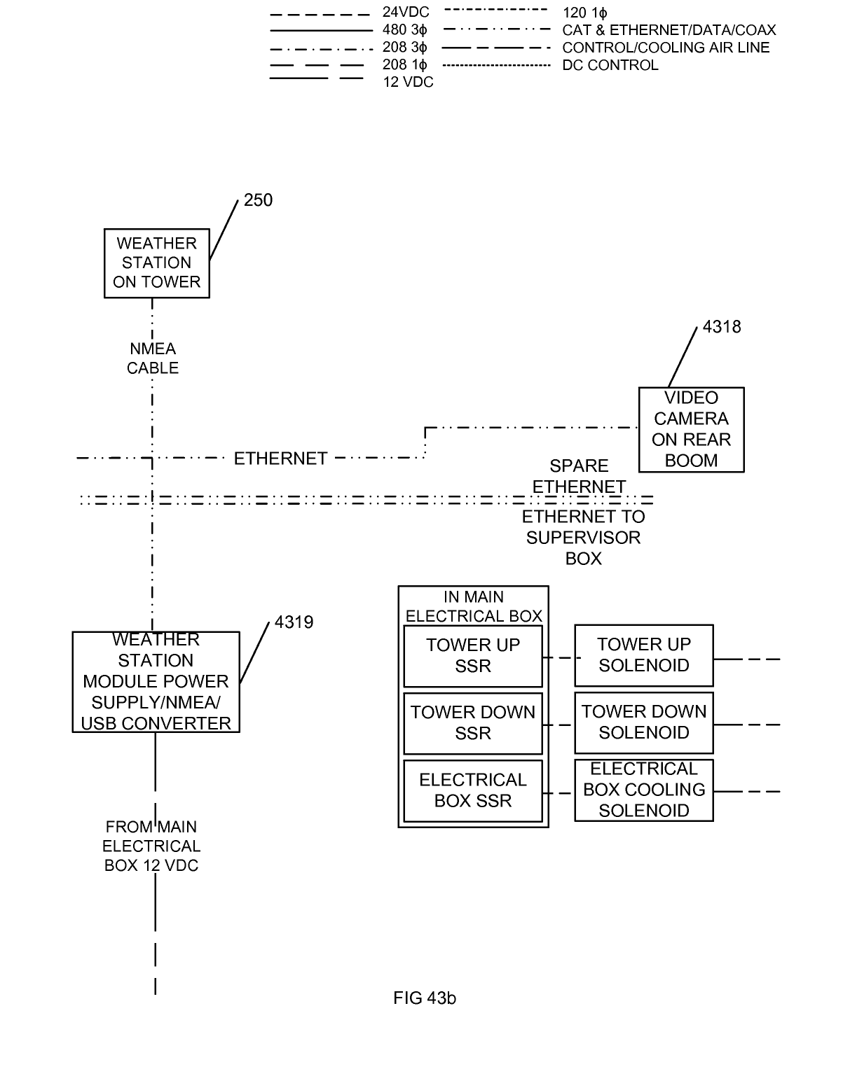

FIGS. 39a and 39b together provide a block diagram of an overview of the control system 3900 of the material handling machine of FIG. 1. The key in the upper portion of FIG. 39b denotes the type of power that is provided through each of the indicated lines. The system is made up of interconnected components that are represented on this overview. Details of major components are more fully described on individual FIGS. 40a-43b and complete the description of the controls. The types and flow of power and information are indicated between the components of the system. The Main Electrical Box 3902 includes circuit breakers, disconnects and takes power from the a main electrical box, which can obtain power from generator 110 (Shown as 3906 on FIG. 39a) of the material handling machine 100, or from an external source, often referred to as shore power 3908, and then distributes the power throughout the control system 3900. Contained within the Main Electrical Box, further detailed in FIGS. 41a and 41b, is a slave PLC (Programmable Logic Controller) which provides control and data acquisition functions under the direction of the Master PLC contained within the Supervisor Station 3904 and detailed on FIGS. 40a and 40b which has overall control of the system. The Main Electrical Power is directly connected and controls power to the Air Compressor 3910, the battery box and chargers 3912 for the backup power systems. The Power Distribution Box 3914, further detailed in FIGS. 42a and 42b, is located near the operational portion of the Material Handling System 100 and provides connection and power to operational components of the system at the command of the Supervisor Station 3904. The computer electrical box 3916, further detailed in FIGS. 43a and 43b, is contains a full computer system for communicating with a Network Operating Station and providing real-time data, status, video and photographs during operation. Many of the Pneumatic controls illustrated in FIG. 37 are also included in computer electrical box 3916.

FIGS. 40a and 40b together provide a supervisor box functional block diagram of the control system 4000 of the material handling machine of FIG. 1. The master PLC 4002 (supervisor box) is the main control point of the control system 4000. The master PLC 4002 also performs all of the control logic functions for the operation of the material handling machine 100. As illustrated, the master PLC 4002 connects to an Ethernet switch 4004 through line 4014, which connects to a computer box through line 4006, a touch screen supervisor panel 4008 through line 4010, and to a power distribution box through line 4012 and to the computer and Main Electrical Box through line 4006. The master PLC 4002 connects to a touch screen for a first bagging operator panel 4016 through line 4018, and to a touch screen for a second bagging operator panel 4020 through line 4022. The master PLC 4002 connects to a first PLC output block 4024, located in a power distribution box, through line 4026, and to a first PLC input block 4028, also located in a power distribution box, through line 4030. The master PLC 4002 connects to a second PLC output block 4032 through line 4034, which can have connections to each of: a supervisor light system 4036, a roadside exterior light system 4038, a curbside exterior light system 4040, a panel light system 4042, an interior enclosure light system 4044, a rear light system 4046, a first conveyor line light system 4048, a second conveyor light system 4050, a first bag clamp solenoid system 4052, and a second bag clamp solenoid system 4054. The master PLC 4002 connects to a second PLC input block 4056 through line 4068, which can have connections to each of: a safety and data system hydraulic station 4058, a first safety and control system for the first material conveyor 4060, a second safety and control system for the second material conveyor 4062, a safety and operations input system 4064 for a first bagging operator, and a safety and operations input system 4066 for a second bagging operator. As illustrated, the master PLC 4002 can also be connected to a power distribution box 4070 for 24 volt DC distribution. The power switcher 4070 can receive switched 24 volt DC power from a primary 24 volt DC power distribution box 4072, and can be connected to each of the systems described above that require 24 volt DC power. The liftgate safety lockout 4074 can also be connected to the power distribution box 4070.

FIGS. 41a and 41b together provide a main electrical box functional block diagram of the control system 3900 of the material handling machine of FIG. 1. FIG. 41a illustrates the slave PLC 4100, which responds to requests from Master PLC 3902. The slave PLC 4100 converts analog signals into engineering units. The slave PLC 4100 also monitors and turns on/off power from the generator or external source through power switch 4102, at the command of the master PLC 3902. The main circuit breaker 4104 is connected to the power switch 4102. The slave PLC 4100 monitors and controls the power through power distribution boxes 4106, 4108, and 4110. The slave PLC 4100 is also connected to a PLC output box 4112, which can be sued to monitor and control various systems of the material handling machine 100, including the tower auxiliary air compressor system 4114 for the tower auxiliary air compressor 3741, the main tower light system 4116, the emergency tower light system 4118, the tower up solenoid system 4120, the tower down solenoid system 4122, the auxiliary light system 4124, the tower rotation actuator system 4128, the box cooling solenoid system 4130 for the computer 4200 (FIG. 42a), and the power system for the computer 4200 (FIG. 42a). The slave PLC 4100 is also connected to the air compressor motor 3704.

FIGS. 42a and 42b together provide an electrical box functional block diagram of the control system 3900 of the material handling machine of FIG. 1. As illustrated, control signals from the supervisor box PLC are received in the electrical box 4200, and used to control power distribution to various systems of the material handling machine 100. With respect to the Hydraulic system 3800, the electrical box 4200 controls power to the sensors and solenoids of the first and second hydraulic systems 3802 and 3804 at 4202. The electrical box 4200 also controls power to the first hydraulic motor 3832, the second hydraulic motor 3846, and the hydraulic system oil heater 3808. The electrical box 4200 further controls power to a first cooling fan motor 4204 for a cooling fan of the first hydraulic system 3802 and a second cooling fan motor 4206 for a cooling fan of the second hydraulic system 3804. With respect to the lift gate 118 of the material handling machine 100, the electrical box 4200 controls power to both the lift gate controls 4208 and the lift gate 118. With respect to the production line 202 (shown in FIG. 18), the electrical box 4200 controls power to each conveyor belt of the production line 202, including first and second production conveyors 204, first and second incline conveyors 206, and first and second shuttle conveyors 208. The electrical box 4200 can also control power to first and second sewing stations 218 through first sewing power line 4210 and second power line 4212, respectively. The electrical box 4200 can further control power for rear street side external power 4214, rear rail gate external power 4216, and the environmental control system 4218 for the operator's work area.

FIGS. 43a and 43b together provide a computer box distribution box functional block diagram of the control system 3900 of the material handling machine of FIG. 1, showing the power and data connections to and from the computer 4300. The computer 4300 is connected to a managed Ethernet switch 4302, which connects to the video camera 248 on the tower 240. The computer 4300 is also connected to a cellular Ethernet connection 4304, which connects to the cellular antenna 246 on the tower 240. The computer 4300 is also connected to a WiFi and wireless access point 4310, which can have a first connection 4308 located on a first air compressor cover, and a second connection 4312 located on a second air compressor cover. The computer 4300 is further connected to a weather station module power supply and converter 4314, which is connected to the weather station 250 on the tower 240.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A material handling machine comprising:
a hopper and conveyor assembly, including a hopper and a material conveyor assembly, wherein the hopper receives a material to be bagged, and the material conveyor assembly includes at least one material conveyor that conveys the material out of the hopper and into a chute provided at an end of the at least one material conveyor;
wherein the hopper includes a material flow gate, the material flow gate including a gate opening and a gate flap, wherein the gate opening and the gate flap define a cross sectional area of the material gate, and the material conveyed through the material gate by the material conveyor conforms to the cross sectional area of the material gate; and
a volume of the material that is dispensed into a bag through the chute is determined by controlling a distance that a conveyor belt of the material conveyor advances and the cross sectional area of the material gate.

2. The material handling machine of claim 1, further comprising a base, the hopper and conveyor assembly being attached to the base.

3. The material handling machine of claim 2, further comprising a storage compartment attached to the base.

4. The material handling machine of claim 2, further comprising a lift gate attached to a back end of the base.

5. The material handling machine of claim 4, wherein the lift gate comprises two vertical rails upon which a platform of the lift gate can be raised and lowered.

6. The material handling machine of claim 4, wherein the lift gate comprises a platform and a fold down fence, the fold down fence having an upright position and a folded down position.

7. The material handling machine of claim 6, wherein the fold down fence comprises at least one driving accessory selected from the group consisting of brake lights, turn signals, license plate lights, and a license plate mounting bracket.

8. The material handling machine of claim 1, further comprising an air tank and a compressor operatively connected to the hopper and conveyor assembly that are configured to provide air for pneumatically driven equipment.

9. The material handling machine of claim 8, further comprising a compartment that houses the air tank and the compressor.

10. The material handling machine of claim 1, further comprising a power generator operatively connected to the hopper and conveyor assembly.

11. The material handling machine of claim 1, wherein the at least one material conveyor includes a motor/sensor assembly located on a central axis of a first roller of the material conveyor, wherein a sensor portion of the motor/sensor assembly measures the rotation of the first roller and calculates a distance that a conveyor belt of the material conveyor has traveled based on the amount of rotation of the first roller.

12. The material handling machine of claim 1, comprising two material conveyors.

13. The material handling machine of claim 12, wherein the hopper comprises trough panels that extend upwardly at an angle from spaced points at the bottom of the hopper and meet in a peak between the two material conveyors at a height below a total height of the hopper.

14. The material handling machine of claim 12, wherein the two material conveyors are offset to one side with respect to a centerline of the hopper.

15. The material handling machine of claim 1, wherein an upper cross section of the hopper is a quadrangle having two sides and two ends.

16. The material handling machine of claim 15, wherein the hopper comprises bang boards mounted along the top edge of each side of the hopper that extend a length of the hopper.

17. The material handling machine of claim 16, wherein the hopper comprises diverter panels mounted along the top edge at each end of the hopper that extend a width of the hopper, wherein each diverter panel extends from an end of the hopper at an upward angle.

18. The material handling machine of claim 1, wherein an inside of the hopper is lines with an ultra high molecular weight polymer sheet.

19. The material handling machine of claim 1, wherein the material conveyor comprises a plurality of roller modules and a conveyor belt, the plurality of roller modules being located underneath the conveyor belt, and each roller module comprising two angled trough rollers and one horizontal load roller.

20. The material handling machine of claim 1, wherein the cross sectional area of the material flow gate is adjusted by adjusting the height of the gate flap.

21. The material handling machine of claim 1, wherein the height of the gate flap is adjusted by rotating a gate handle.

22. The material handling machine of claim 1, wherein the material flow gate has inward sloping sides and is wider at a bottom than at a top.

23. The material handling machine of claim 1, further comprising a volume chamber that extends from the material flow gate to an end of the material conveyor.

24. The material handling machine of claim 1, further comprising a spout extending beneath the chute, the spout having a top opening attached to the chute that is wider than a bottom opening through which material exits the spout into a bag.

25. The material handling machine of claim 24, wherein the spout comprises at least one proximity detector and at least one bag clamp, wherein the bag clamp closes when the proximity detector detects an operator's hand within a proximity of the proximity sensor.

26. The material handling machine of claim 25, wherein the spout comprises at least two proximity detectors and at least two bag clamps.

27. The material handling machine of claim 1, wherein the chute comprises guides that extend downwardly into the chute at an angle to guide material towards the center of the chute.

28. The material handling machine of claim 1, wherein the hopper includes a cover grate having a lowered position and a raised position.

29. The material handling machine of claim 1, further comprising a production line including a production conveyor extending from the chute.

30. The material handling machine of claim 29, the production line further comprising a sewing station at a distal end of the production conveyor from the chute.

31. The material handling machine of claim 29, the production line further comprising an inclined conveyor extending from the production conveyor.

32. The material handling machine of claim 31, wherein the production conveyor and the inclined conveyor have a stored position on open frame rails that retain the production conveyor and the inclined conveyor within a framework of the base.

33. The material handling machine of claim 31, the production line further comprising a shuttle conveyor at an end of the inclined conveyor.

34. The material handling machine of claim 33, wherein the shuttle conveyor has two ends and is positioned crossways with respect to the inclined conveyor.

35. The material handling machine of claim 33, wherein the shuttle conveyor comprises a reversible conveyor belt.

36. The material handling machine of claim 35, wherein the reversible conveyor belt is attached to a trolley that shifts the reversible conveyor belt from side to side so that each end of the reversible conveyor belt extends over and shifts across an interior of a storage sack.

37. The material handling machine of claim 33, wherein a storage sack is located at each end of the shuttle conveyor.

38. The material handling machine of claim 37, wherein each storage sack is supported on a storage sack stand.

39. The material handling machine of claim 38, wherein each storage sack includes loops that secure the storage sack to a storage sack stand.

40. The material handling machine of claim 38, wherein each storage sack stand comprises:
a plurality of horizontal braces that slidably mate with each other so that the length and width of the storage sack stand can be adjusted; and
a plurality of vertical braces that include at least two slidably mated portions so that the height of the storage sack stand can be adjusted;
wherein at least two horizontal braces are foldably attached to each vertical brace.

41. The material handling machine of claim 40, each storage sack stand further comprising a plurality of hangers, each hanger being slidably received by a vertical brace.

42. The material handling machine of claim 1, further comprising a tower attached to the base, the tower comprising a shaft and a head.

43. The material handling machine of claim 42, wherein the shaft of the tower is pneumatically raised and lowered.

44. The material handling machine of claim 42, wherein the head of the tower comprises a cellular antenna that allows the control systems of the material handling machine to be operated remotely.

45. The material handling machine of claim 42, wherein the head of the tower comprises a camera.

46. The material handling machine of claim 42, wherein the head of the tower comprises a weather station that monitor aspects of weather.

47. The material handling machine of claim 42, wherein the head of the tower comprises at least one light.

48. The material handling machine of claim 42, wherein the head of the tower rotates relative to the shaft.

49. A material handling machine comprising:
a base;
a power generator attached to the base that provides electrical power;
an air tank and a compressor attached to the base that are configured to provide air for pneumatically driven equipment; and
a hopper and conveyor assembly attached to the base, including a hopper and a material conveyor assembly, wherein the hopper receives a material to be bagged, and the material conveyor assembly includes at least one material conveyor that conveys the material out of the hopper and into a chute provided at an end of the at least one material conveyor;
wherein the material conveyor comprises a plurality of roller modules and a conveyor belt, the plurality of roller modules being located underneath the conveyor belt, and each roller module comprising two angled trough rollers and one horizontal load roller.

50. A material handling machine comprising:
a hopper and conveyor assembly including a hopper and a material conveyor assembly, wherein the hopper receives a material to be bagged, and the material conveyor assembly includes at least one material conveyor that conveys the material out of the hopper and into a chute provided at an end of the at least one material conveyor; and
a production line including a production conveyor extending from the chute.

51. The material handling machine of claim 50, the production line further comprising a sewing station at a distal end of the production conveyor from the chute.

52. The material handling machine of claim 50, the production line further comprising an inclined conveyor extending from the production conveyor.

53. The material handling machine of claim 52, wherein the production conveyor and the inclined conveyor have a stored position on open frame rails that retain the production conveyor and the inclined conveyor within a framework of the base.

54. The material handling machine of claim 52, the production line further comprising a shuttle conveyor at an end of the inclined conveyor.

55. The material handling machine of claim 54, wherein the shuttle conveyor has two ends and is positioned crossways with respect to the inclined conveyor.

56. The material handling machine of claim 55, wherein the shuttle conveyor comprises a reversible conveyor belt.

57. The material handling machine of claim 56, wherein the reversible conveyor belt is attached to a trolley that shifts the reversible conveyor belt from side to side so that each end of the reversible conveyor belt extends over and shifts across an interior of a storage sack.
